(19) United States
(12) Patent Application Publication
(10) Pub. No.: US 2009/0210519 A1
(43) Pub. Date: Aug. 20, 2009

(54) EFFICIENT AND TRANSPARENT REMOTE WAKEUP

(75) Inventors: Brian Don Zill, Bellevue, WA (US); David Garfield Thaler, III, Redmond, WA (US); Parveen K. Patel, Redmond, WA (US); Rebecca Isaacs, Cambridge (GB); Yongguang Zhang, Redmond, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/032,975

(22) Filed: Feb. 18, 2008

(51) Int. Cl. G06F 15/177

(52) U.S. Cl. 709/220

(57) ABSTRACT

Systems and methods that facilitate remote wake up are described that provide for efficient and transparent wake up of target hosts by remote hosts. In various embodiments, a separate address can be used by a target host for wake up network traffic, which is different from a regular address associated with a target host for normal network communications. In addition, the disclosed subject matter facilitates controlling wake up operations according to trust, identity, and/or a wake up policy.

### TECHNICAL FIELD

The subject disclosure relates to computing systems and more particularly to systems and methods that facilitate efficient and transparent remote wakeup.

### BACKGROUND

With the proliferation of computers and networks, system administrators quickly developed a demand for the ability to remotely restore computers over a network (e.g., such as over a local area network (LAN)) to facilitate remote access, remote administration, installation of updates, and so on. Wake on LAN (WOL) is a group of technologies composed of cooperating hardware and software components that have developed to meet this demand. Typically, network devices or on-board network chips have filters that are configurable by a host operating system to allow selection of recognizable patterns of network traffic for usage as a proper WOL signal. Once configured, the target computer can be powered down into a reduced power and reduced availability mode (e.g., a sleep mode), with power reserved for the network device (e.g., into a wake up state). The network device then listens for the specific pattern. Thus, network traffic received at the target computer that matches one of the patterns can be checked and validated, upon which, the network device can signal the target host (e.g., a target computer) to power up the computer (e.g., wake up).

For example, wake frame events can be used to wake a target system whenever meaningful data is presented to the system over the network. Examples of meaningful data can include the reception of a Magic Packet, a management request from a remote administrator, or simply network traffic directly targeted to the local system. In all of these cases, the network device is typically pre-programmed with information on how to identify wake frames from other network traffic. Before putting the network adapter into the wake up state, the system configures the network device (e.g., passes to the adapter's driver a list of sample frames and corresponding byte masks) to provide the network device with an example of a frame that should wake up the system. For example, each byte mask can define which bytes of the incoming frames should be compared with the corresponding sample frame in order to determine whether or not to accept the incoming frame as a wake-up event.

However, disadvantages of conventional WOL solutions lead to limited deployment of remote wakeup technologies and result in lost opportunity for saving energy. For example, a network can have a significant amount of background noise due to various protocols communicating in the background. Consequently, as a result of some background traffic, a machine can be prevented from entering a sleep mode.

One common solution to provide WOL can be to allow receipt of specially patterned network packets to wake target computers equipped and configured to respond to the packets. One of these patterns is referred to as a Magic Packet™ and can be used in the situation where the target machine's Media Access Control (MAC) address is known. This pattern is typically comprised of 16 duplications of the target computer's network device MAC address, with no breaks or interruptions, preceded by a synchronization stream defined as 6 bytes of FFh (FF hexadecimal).

Another problem can lead to not being able to wake up the target host from the remote host. For instance, many networks are separated by routers to segment the LAN into a number of subnets as well as to reduce the amount of broadcast traffic on each segment. As its name implies, WOL was developed for use over LANs. Although there may be nothing fundamentally different between a packet received from another LAN subnet or from the internet and one received from within the same subnet, problems can arise that center on how to ensure that the traffic arrives at the appropriate target machine or target machine's subnet (e.g., for broadcast traffic).

For example, if routers exist between the remote host machine and the target host machine, then the remote host typically only knows the MAC address of the router nearest the remote host and not the machines (e.g., additional routers and specifically the target host) on the other side of this router. Thus, although a remote host may know a target machine's Internet Protocol (IP) address or name, if the target machine's MAC address is not known, then the Magic Packet™ pattern cannot be formed.

In addition, WOL is a broadcast protocol. Thus, when an organization's routers do not forward broadcast packets (e.g., configured to block broadcast packets), then the WOL packets can also be blocked at the router. While some routers can be configured to allow forwarding of User Datagram Protocol (UDP) broadcasts (e.g., broadcasts to UDP port 9), others such as Network Address Translation (NAT) based residential gateways (e.g., cable or digital subscriber line (DSL) gateways) appliances typically do not allow passing such WOL packets.

In addition, the translation between IP and MAC addresses is performed using the Address Resolution Protocol (ARP) in IP version 4 (IPv4) and Ethernet networks. However, the aging of ARP cache tables in routers can result in the MAC address of the target host being removed from the ARP cache of the last hop router (e.g., the router nearest the target host). Thus, when a frame is received in a router whose destination IP address is not in the ARP cache, the router will send an ARP request packet out onto the network for the destination IP address. Because it is a broadcast packet, an ARP request is typically received and processed by all the hosts in the network. However, if the target host is asleep and in Magic Packet™ mode, it will not respond to this ARP request. As a result, router will just discard the frame thereby restricting the ability to remotely wake up the target host over a routed network.

Moreover, while a host can be configured to recognize hardware address resolution request (e.g., ARP or IPv6 neighbor discovery request) as a wake-up pattern, this can lead to further problems. For example, assuming a remote host has already resolved the target host's name and IP address and has determined the target host's MAC address, traffic can be sent directly to the target host via a directed MAC address header. As above, if a remote host attempts to send traffic to the target host with the target host's IP address, the last hop router (e.g., the router nearest the target host) attempts to resolve the target host's MAC address. In response to receiving the hardware address resolution packets, the sleeping target host's network device can recognize the traffic as a wake-up pattern. However, if the target host then attempts to return to a sleep mode, the fact that the router could still retain the mapping between the target host's IP address and MAC address could result in packets sent directly to the target host with the mapped MAC address without the directed MAC address header. As a result, this can prevent the target host from returning to a sleep mode.

Although using an IP directed broadcast is one potential solution, this is not without its own drawbacks. In an IP directed broadcast, rather than addressing the WOL packet to the target host net mask (e.g., 255.255.255.255), each WOL packet can be addressed to the IP broadcast network address where the target host is located (e.g., net mask 255.255.255.0). Thus, an IP directed broadcast datagram can be sent to the broadcast address of a subnet to which the remote host is not directly attached. This directed broadcast can then be routed through the network as a unicast packet until it arrives at the target subnet. Due to IP addressing architecture, only the last hop router in the chain (e.g., the router connected directly to the target subnet) can conclusively identify a directed broadcast, which can convert it into a link-layer broadcast packet.

While this can ensure the ability to send WOL packets to wake up any connected target host, the intermediate routers have to be configured to allow passage of IP directed broadcasts, which can create network vulnerabilities to extremely common and popular “smurf” and related denial of service attacks.

In addition, conventional WOL solutions do not readily allow controlling what entities are authorized to remotely wake up a target host because there is no notion of identity in the structure of the patterns. For instance, typical limitations of network device require WOL patterns that are fairly simplistic, such as comprising a specified byte offset and mask and requiring the pattern to appear in the first 128 bytes of a packet, for example. As a result of these limitations (lack of the notion of identity in a WOL signal, lack of the ability to reliably restrict remote wake capabilities, and so on), interesting and complex operations involving WOL capabilities are difficult at best, if not resulting in inelegant, unworkable, and/or inoperative solutions.

The above-described deficiencies are merely intended to provide an overview of some of the problems encountered in remote wakeup of target hosts, and are not intended to be exhaustive. Other problems with the state of the art may become further apparent upon review of the description of the various non-limiting embodiments of the disclosed subject matter that follows.

### SUMMARY

In consideration of the above-described deficiencies of the state of the art, the disclosed subject matter provides systems and methods that facilitate efficient and transparent remote wakeup.

Accordingly, the disclosed subject matter can facilitate securely waking up a target machine remotely, including remotely over the Internet, while minimizing changes to existing infrastructure (e.g., changes to target and/or remote hosts). Accordingly, in various non-limiting embodiments of the disclosed subject matter, a target host can use a separate IP address (e.g., separate from an IP address used for non-wakeup or normal traffic) to facilitate receipt of wake up packets. By implementing changes at resolution servers (e.g., name resolution servers such as Domain Name System (DNS) servers), various aspects of the disclosed subject matter can facilitate remote wake up of a target host that is transparent to applications and/or remote hosts. In further non-limiting embodiments, aspects of the disclosed subject matter can facilitate efficient and transparent remote wakeup of target hosts without changes to remote hosts. In addition, the disclosed subject can facilitate authorizing trusted remote hosts to securely wake a target host.

In consideration of the above-described limitations, in accordance with exemplary non-limiting embodiments, the disclosed subject matter can facilitate efficient and transparent remote wakeup. In various non-limiting embodiments, the disclosed subject matter provides methods facilitating remote wake up of a target host.

Accordingly, methods are provided that facilitate remote wake up of a target host that can comprise acquiring, by the target host, a separate address to receive wake up network traffic. The methods can further include communicating the separate address, as well as a wake up policy, to a computer system (e.g., a remote host and/or a resolution server) prior to the target host entering a sleep mode. The methods can further include receiving, by the target host, wake up network traffic associated with the separate address. In addition, the methods can include restoring, by the target host, from the sleep mode to resume network communications using an address distinct from the separate address.

In further consideration of the above-described limitations, various embodiments of the disclosed subject matter provide systems facilitating remote wake up. Accordingly, various embodiments of the disclosed subject matter can comprise a target host or a resolution server configured according to the various aspects of the disclosed subject matter.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the disclosed subject matter in a simplified form as a prelude to the more detailed description of the various embodiments of the disclosed subject matter that follows.

### BRIEF DESCRIPTION OF THE DRAWINGS

Efficient and transparent remote wake up of target hosts, and related systems and methods are further described with reference to the accompanying drawings in which:

FIG. 1 illustrates an overview of an exemplary network environment suitable for incorporation of embodiments of the disclosed subject matter;

FIG. 2 illustrates another overview of an exemplary network environment suitable for incorporation of embodiments of the disclosed subject matter;

FIG. 3 illustrates an exemplary non-limiting block diagram of a target host system that facilitates efficient and transparent remote wakeup according to various embodiments of the disclosed subject matter;

FIG. 4 illustrates an exemplary non-limiting block diagram of a remote host system according to various embodiments of the disclosed subject matter;

FIG. 5 illustrates an exemplary non-limiting block diagram of a resolution system that facilitates efficient and transparent remote wakeup according to various embodiments of the disclosed subject matter;

FIG. 6 depicts a timing diagram of an exemplary non-limiting communication process for remote wake up of a target host according to various embodiments of the disclosed subject matter;

FIG. 7 depicts a timing diagram of an exemplary non-limiting communication process for remote wake up of a target host according to further embodiments of the disclosed subject matter;

FIG. 8 illustrates a particular non-limiting high level methodology that facilitates efficient and transparent remote wakeup according to various aspects of the disclosed subject matter;

FIG. 9 illustrates a particular non-limiting high-level methodology that facilitates efficient and transparent remote wakeup according to further aspects of the disclosed subject matter;

FIG. 10 is a block diagram representing an exemplary non-limiting networked environment in which the disclosed subject matter can be implemented; and

FIG. 11 is a block diagram representing an exemplary non-limiting computing system or operating environment in which the disclosed subject matter can be implemented.

### DETAILED DESCRIPTION

### Overview

Simplified overviews are provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the disclosed subject matter in a simplified form as a prelude to the more detailed description of these and various other embodiments of the disclosed subject matter that follow. It is understood that various modifications may be made by one skilled in the relevant art without departing from the scope of the disclosed subject matter. Accordingly, it is the intent to include within the scope of the disclosed subject matter those modifications, substitutions, and variations as may come to those skilled in the art based on the teachings herein.

In consideration of the above-described limitations, the disclosed subject matter facilitates efficient and transparent remote wake up of target hosts, in accordance with exemplary non-limiting embodiments. According to an aspect of the disclosed subject matter, a target host can be configured to use a separate IP address to facilitate receipt of wake up packets as distinguished from and IP address used for regular traffic. Accordingly, the disclosed subject matter can facilitate waking a target host from a remote host transparently in response to requests for communication received at the target host (e.g., via the separate IP address, either from a trusted remote host, by address resolution via suitably configured resolution server, and/or via a proxy or other trusted third party device).

As used in this application, the term “host” can refer to a computer or a computer-related entity at a specific location on a computer network. Typically, a host can comprise a storage component (e.g., volatile and non-volatile storage and associated software for storage and/or execution of data and instructions), a host processor (e.g., for controlling the functions of the host according to data and/or instructions), and a communications component (e.g., one or more network devices and associated software for communication with other network components). In addition, a location on a network can be described by an IP address. Thus, in addition to including such computer-related entities as desktop computers, laptop computers, server computers, network attached appliances with computing capability, and so on, the term host can include, for example, a tablet personal computer (PC) device, a Smartphone, and/or a personal digital assistant (PDA), and so on. In addition, as used herein, the term “target host” can refer to a computer-related entity capable of entering and being restored from a low power and reduced availability state (e.g., a sleep mode), and with which it is desirable to initiate communications. The term “remote host” as used in this application can refer to a computer-related entity capable of initiating communications with the target host (e.g., whether the target host is in a sleep mode or otherwise).

Furthermore, as used in this application, the terms “component,” “module,” “system,” and the like are intended to refer to a computer-related entity, either hardware, firmware, a combination of hardware and software, software, software in execution, firmware, middle ware, microcode, and/or any combination thereof. For example, a component can be, but is not limited to being, a process running on a processor, a processor, an object, an executable, a thread of execution, a program, and/or a computer. By way of illustration, not limitation, both an application running on a computing device and the computing device can be a component. One or more components can reside within a process and/or thread of execution and a component can be localized on one computer and/or distributed between two or more computers.

In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal). Additionally, components of systems described herein can be rearranged and/or complemented by additional components in order to facilitate achieving the various aspects, goals, advantages, etc., described with regard thereto, and are not limited to the precise configurations set forth in a given figure, as will be appreciated by one skilled in the art.

Moreover, various embodiments of the disclosed subject matter are directed to methods. It is to be understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The method claims appended hereto present elements of the various steps in a sample order, and are not meant to be limited to the specific order or hierarchy presented.

### Efficient and Transparent Remote Wakeup

Advantageously, the disclosed subject matter can facilitate securely waking a target machine remotely, including remotely over the Internet, while minimizing changes to existing infrastructure. Advantageously, various aspects of the disclosed subject matter can be implemented without hardware changes (e.g., changes to target and/or remote hosts or associated network devices, such as network interface cards (NICs)). In various non-limiting embodiments of the disclosed subject matter, a target host (e.g., a host for which remote wake up can be configured) can be configured to use a separate address (e.g., separate from an address used for non-wakeup traffic, such as a separate IP address) to facilitate receipt of wake up packets (hereinafter referred to as a “wake up address,” a “wake up IP address,” or a “wakemeaddress”).

According to various aspects of the disclosed subject matter, implementing changes at resolution servers (e.g., name resolution servers such as DNS servers), the disclosed subject matter can facilitate remote wake up of a target host that is transparent to applications and/or remote hosts. In further non-limiting embodiments, aspects of the disclosed subject matter can facilitate efficient and transparent remote wakeup of target hosts without changes to remote hosts, in addition to providing an ability to grant permission to an authorized remote host to securely wake up a target host. Accordingly, the disclosed subject matter can facilitate waking a target host from a remote host transparently in response to requests for communication received at the target host (e.g., via the separate IP address, either from a trusted remote host, by address resolution via suitably configured resolution server, and/or via a proxy or other trusted third party device).

In addition, the disclosed subject matter can facilitate reliable entry of target hosts into sleep modes in the presence of problematic traffic (e.g., traffic that could otherwise prevent target hosts from entering a sleep mode), such as background traffic to a target host (e.g., traffic from hosts that have previously resolved a target host's regular IP address and which has been resolved to a target host's MAC address). For example, directing wake up traffic to a separate IP address that is different from that used for regular traffic (e.g., already resolved), the disclosed subject matter can facilitate reliable entry of target hosts into sleep modes, for example, in the situation where a directed MAC address pattern received at a target host can otherwise prevent a target host from going to sleep. Furthermore, according to various aspects of the disclosed subject matter, traffic that has not already resolved to the target host's regular IP address and MAC address can be considered as a new connection (e.g., traffic that is a candidate for remote wake up), which can be directed to the wake up IP address, based in part on considerations described herein.

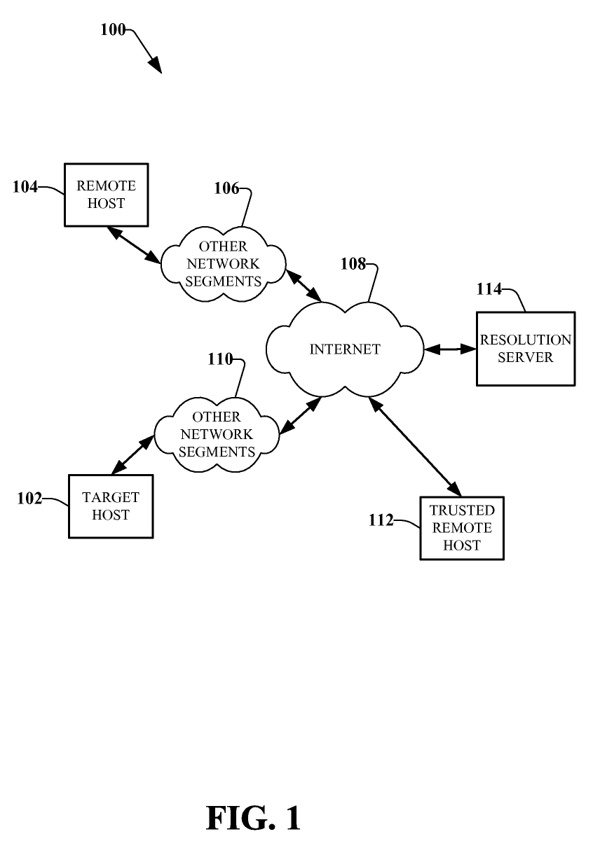

FIG. 1 illustrates an overview of an exemplary network environment 100 suitable for incorporation of embodiments of the disclosed subject matter. Network environment 100 can comprise a number of components that facilitate efficient and transparent remote wakeup according to various aspects of the disclosed subject matter, among other related functions. While various embodiments are described with respect to the components of network environment 100 and the further embodiments more fully described below, one having ordinary skill in the art would recognize that various modifications could be made without departing from the spirit of the disclosed subject matter. Thus, it should be understood that the description herein is but one of many embodiments that may be possible while keeping within the scope of the claims appended hereto.

According to various non-limiting embodiments of the disclosed subject matter, network environment 100 can comprise a target host 102. Target host 102 can be a computer or a computer-related entity at a specific location on a computer network, which is capable of entering and being restored from a low power and reduced availability state (e.g., a sleep mode), and with which it is desirable to initiate communications. For example, target host 102 can be a server computer on a network having a location as described by a network address such as, for example, an IP address. Thus, in addition to including such computer-related entities as server computers, laptop computers, network attached appliances with computing capability (e.g., a network attached storage (NAS) appliance), and so on, depending on the ability of a device to enter and be restored from a low power and reduced availability state (e.g., a sleep mode), the term target host can include, for example, a tablet personal computer (PC) device, a Smartphone, and/or a personal digital assistant (PDA), and so on.

Additionally, target host 102 can be associated with one or more network devices for communication with attached networks. In addition, conventional host network devices or on-board network chips have filters that are configurable by the host operating system to allow selection of recognizable patterns of network traffic for usage as a proper WOL signal. Advantageously, various embodiments of the disclosed subject matter can facilitate efficient and transparent remote wake up of target hosts without hardware modifications. For instance, a target host 102 according to the disclosed subject matter can be configured to use a separate IP address (e.g., separate from an IP address used for non-wakeup traffic) before entering low power and reduced availability state (e.g., a sleep mode) to facilitate receipt of wake up packets.

Generally, this separate IP address (e.g., a wake up address, a wake up IP address, or a wakemeaddress) is different than that used for normal communications (e.g., a regular IP address) while the target host powered up and available. In addition, prior to entering a sleep mode, the separate IP address (e.g., a wake up address, a wake up IP address, or a wakemeaddress) can be communicated (e.g., by target host 102) to various components of network environment 100 for initiating communications with target host 102 after it has entered sleep mode. Thus, before entering sleep mode, a network device of a target host 102 can be configured to recognize patterns of network traffic corresponding to attempts to resolve the separate IP address of the target host 102. For example, target host 102 can update its associated network device to wake up target host 102 if it receives a network traffic pattern such as an ARP request or an IPv6 Neighbor Discovery request for the separate IP address associated with target host 102 and not for the regular IP address.

According to further non-limiting embodiments of the disclosed subject matter, network environment 100 can include a remote host 104 connected to target host 102 via various computer networks and/or network segments. For example, remote host 104 can be connected to other network segments 106 to internet 108. In turn, target host 102 can be connected to other networks segments 110 to internet 108. While for purposes of illustration, other network segments 106 and 110 are depicted generally, it is to be appreciated that any suitable network infrastructure can be used for initiating communications with target host 102 and for communicating information to remote host 104 from target host 102 and/or other components of network environment 100 to facilitate remote wake up of target host 102.

Thus, it is to be appreciated that, in addition to the network communications infrastructure described herein, for example with reference to FIGS. 1, 2, and 10, various modifications can be made to the disclosed network environments while keeping within the scope of the claims appended hereto. For purposes of illustration, other network segments 106 and/or 110 can include wireless links and components in addition to wired links and components, as well as other components such as routers, gateways, firewalls, switches, and/or servers (e.g. authentication, authorization, and/or accounting (AAA) servers, file servers, web servers, database servers, etc.), and so on. As a further illustration, it is conceivable that a suitable wireless network device (e.g., a wireless LAN card) associated with target host 102 can be configured to facilitate remote wakeup of target host 102 including wireless receipt of network traffic patterns to be used as a WOL signal while in a sleep mode.

Thus, remote host 104 can be a computer or a computer-related entity at a specific location on a computer network, which is capable of initiating communications with target host 102 (e.g., whether target host 102 is in a sleep mode or otherwise) and receiving information from target host 102 and/or other components of network environment 100 to facilitate remote wake up of target host 102. For example, remote host 104 can be a computer on a network (e.g., a LAN, either wired or wireless, and/or the internet) having a location as described by a network address such as, for example, an IP address. Thus, in addition to including such computer-related entities as server computers, laptop computers, network attached appliances with computing capability (e.g., a NAS appliance), and so on, depending on the ability of a device to initiate communications with target host 102, the term remote host can include, for example, a tablet personal computer (PC) device, a Smartphone, and/or a personal digital assistant (PDA), and so on.

Accordingly, remote host 104 can be configured to receive information from target host 102 and/or other components of network environment 100 to facilitate remote wake up of target host 102. For example, remote host 104 can be configured to receive a wake up IP address of target host 102 prior to, or upon, attempting to initiate communications with target host 102. As a result, the wake up IP address can be communicated to remote hosts (e.g., that are allowed to wake up target host 102), such as a trusted remote host 112. For example, the wake up IP address can be communicated (e.g., in a Mobile IP binding update, where the original IP address is treated as the Home Address and the wakeup-IP address is the Care-of-Address). As a further example, the wake up IP address can be communicated to remote host 104, such as trusted remote host 112, in the form of information communicated to remote host 104 and/or trusted remote host 112 (e.g., setting a cookie, sending a token, communicating a certificate, and/or other data and/or instructions, and so on).

In addition to information communicated to remote host 104 and/or trusted remote host 112, such as a wake up IP address in a binding update, target host 102 (e.g., directly and/or via other components of network environment 100) can also send information (e.g., a wake up policy) to remote host 104 and/or trusted remote host 112 that can facilitate identifying and controlling the entities (e.g., applications, processes, and/or users, and so on) that are permitted to wake up target host 102. With a properly configured remote host 104, according to various embodiments of the disclosed subject matter, network environment 100 can advantageously facilitate additional benefits such as attaching an identity to a WOL signal and restricting those remote hosts that are authorized to wake up target host 102.

According to further non-limiting embodiments of the disclosed subject matter, network environment 100 can include a resolution server 114 in communication with the components of network environment 100 (e.g., target host 102, remote host 104, trusted remote host 112, and so on). The disclosed subject matter, in one aspect thereof, can include a resolution server 114 configured to resolve a name to a network address such as an IP address. For example, resolution server 114 can include a server configured to resolve a fully qualified domain name to an IP address, such as a DNS server. As a further example, a Session Initiation Protocol (SIP) server can be a type of resolution server based on Uniform Resource Identifier (URI).

Accordingly, resolution server 114 can be configured to include logic that facilitates remote wake up according to various aspects of the disclosed subject matter. For example, resolution server 114 (e.g., a DNS server) can be configured to facilitate resolving a regular IP address of target host 102, for instance when remote host 104 attempts to resolve a name associated with target host 102. Advantageously, communication of a wake up IP address associated with target host 102 to resolution server 114 (e.g., a DNS server) can facilitate remote wake up of target host 102 without modifications to remote hosts.

In addition to information communicated to resolution server 114 (e.g., a DNS server), such as a wake up IP address, target host 102 (e.g., directly and/or via other components of network environment 100) can also send information (e.g., a wake up policy) to resolution server 114 (e.g., a DNS server) that can facilitate identifying and controlling the entities (e.g., applications, processes, and/or users, and so on) that are permitted to wake up target host 102. For example, the disclosed subject matter, in one aspect thereof, can facilitate the grant or denial of permission to remotely wake target host 102 (e.g., by limited disclosure of a wake up IP address associated with target host 102) such that target host 102 or other trusted components of network environment 100 can control remote wake up operations. As a further example, a separate IP address can be maintained secret within a trusted group of components of network environment 100.

Thus, the disclosed subject matter, according to an aspect thereof, can facilitate controlling remote wake up of target host 102 by a resolution server 114 configured to send wakeup traffic to target host 102 according to a target host 102 remote wake up policy that is communicated to resolution server 114. In addition, target host 102 can identify and authorize (e.g., by itself, via other components of network environment 100, or otherwise) trusted hosts (e.g., trusted host 112) and permit various levels of remote wake up capability for trusted hosts according to a target host 102 wakeup policy.

For the purposes of illustration and not limitation, such wake up policies can concern such distinctions (e.g., information basis to restrict or allow operations) as time-based distinctions (e.g., wake up allowed or not allowed during certain dates and times), network information based distinctions (e.g., host name, IP address, port number, protocol, network topology information such as same subnet or limited number of hops, etc.), application-based distinctions (e.g., what computer applications or processes are allowed to or restricted from remotely waking target host), user or host identity-based distinctions (e.g., by password and/or username, authentication protocols, certification protocols, cryptographic protocols, and so on), event-based distinctions (e.g., startup, shutdown, and/or failure of related computer resources such as for backup systems, load-balanced systems, and so on), state-based distinctions (e.g., state of device, machine, host, systems, or network), geographic related distinctions (e.g., such as identified by a mapping of network information such as IP address to geographic information, for example in a DNS LOC record that can give the physical location of a host), and/or the like, and any combination thereof.

According to further non-limiting embodiments of the disclosed subject matter, resolution server 114 (e.g., a DNS server) can be configured to facilitate sending traffic to a wake up IP address associated with target host 102, for the purpose of remotely waking target host 102, when target host is known or can be inferred to be in a sleep mode. Advantageously, various aspects of the disclosed subject matter can facilitate, offloading the decision to wake up target host 102 to resolution server 114 (e.g., a DNS server and/or other name resolution server). As an additional advantage, the disclosed subject matter can facilitate efficient and transparent remote wakeup with slight modifications to existing infrastructure. For example, according to various non-limiting embodiments of the disclosed subject matter, a resolution server 114 operating as a DNS server can be configured to facilitate remote wakeup by remote host 104 of target host 102 by sending traffic to a wakeup IP address of target host 102. Where restricting access to remote wakeup of target host 102 is desired, a resolution server 114 operating as a DNS server can be configured to receive and/or check a target host 102 wake up policy prior to sending traffic to a wakeup IP address of target host 102. It should be appreciated that such capabilities, as well as further related capabilities as would become apparent to those skilled in the art, can be provided by relatively slight changes in existing protocol of the DNS.

Advantageously, according to various non-limiting embodiments of the disclosed subject matter, such modifications can facilitate discriminating between the types of traffic that can be received at target host 102. For instance, new connections to target host 102 typically go through a name resolution process (e.g., through a resolution server 114 such as a DNS server) to get a regular IP address of target host 102. According to various aspects of the disclosed subject matter, this fact can be exploited to distinguish new connections to target host 102 from existing connections that have already resolved to a regular IP address of target host 102. In turn, this distinction can, be exploited by resolution server 114 such as a DNS server configured as described to send traffic to wake up IP address of target host 102 only for new connections. As a result, such modifications can facilitate reliable and transparent remote wake up for new traffic or new connections to target host 102 (e.g., by resolution server 114 such as a DNS server sending traffic to a wake up IP address of target host 102), whereas existing traffic from connections that have resolved to the regular IP address of target host 102 can be ignored when target host 102 is in a sleep mode.

As a further advantage, use of a wake up IP address known to a resolution server 114 such as a DNS server can be conveniently and efficiently implemented within the limited capacity to store WOL patterns in current network devices. For example, consider a web server that can be configured to host any number of domain names on the same machine. As a result, the web server can have a number of regular IP addresses resolving to respective domain names of a target host 102. In addition, current network devices typically support limited numbers of WOL patterns (e.g., typically from four to sixteen patterns) depending on price and complexity of the network device (e.g., a network device of commercial web server versus that for a consumer grade computer). A single wake up IP address of target host 102 that is attached to all domain names and IP addresses served by the web server can facilitate efficient and remote wake up of target host 102. For example, in the event that a resolution server 114 such as a DNS server receives traffic to resolve to target host 102 (e.g., traffic to one of the domain names served by the web server), rather than having a separate wake up IP address for each domain name to IP address resolution pair associated with target host 102 (e.g., web server serving the multiple domain names), a single wake up IP address of target host 102 can facilitate the web server powering down (e.g., entering a sleep mode) when it is not handling any traffic. Then, upon receiving traffic (e.g. a hypertext transfer protocol (http) request), a resolution server 114 such as a DNS server can facilitate remote wake of target host 102 by sending traffic to the single wake up IP address.

It is to be appreciated that the various functions, components, or process steps can be combined or distributed via techniques known in the art or can be eliminated or reorganized according to system design considerations without departing from the scope of the claims appended hereto. For example, while the functions of acquiring and/or communicating a wake up IP address and/or a remote wake up policy, controlling access to remote wake up of target host 102, sending wake up traffic to target host 102, and so on are described as occurring in discrete blocks for purposes of illustration, it should be understood that such functions can be combined or distributed as desired. As a further example, system design considerations may dictate the elimination, optimization, integration, and/or distribution of a set of such functions to meet such design considerations (e.g., efficiency, security, reliability, and so on). Further examples of such modifications will become apparent to those skilled in the art upon review of the various embodiments disclosed and claimed herein.

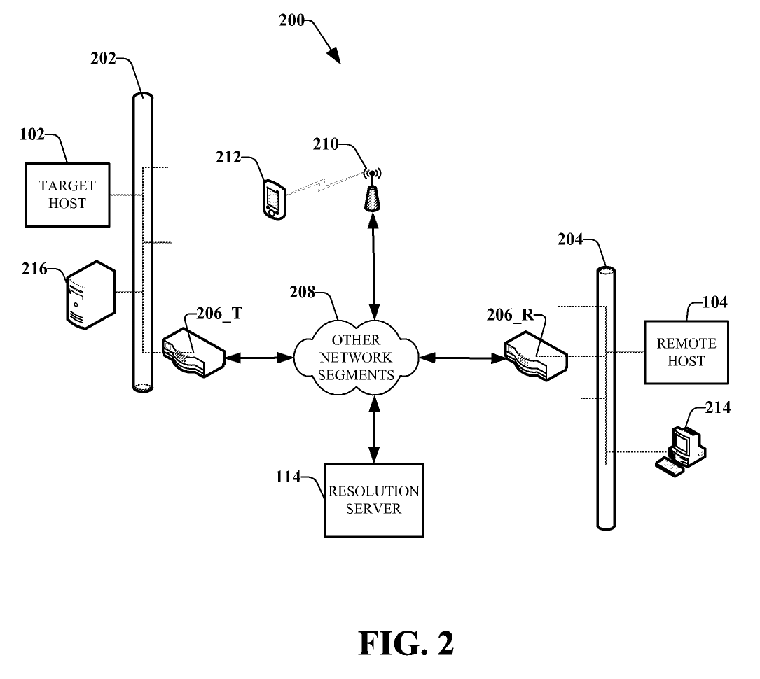

FIG. 2 illustrates an overview of an exemplary network environment 200 suitable for incorporation of embodiments of the disclosed subject matter. As briefly described above with reference to FIG. 1, various non-limiting embodiments of the disclosed subject matter can comprise a target host 102, a remote host 104, and a resolution server 114. It is to be appreciated that target host 102, remote host 104, and resolution server 114 can each include their respective functionality, as more fully described herein, for example, with regard to network environment 100.

According to further non-limiting embodiments of the disclosed subject matter, network environment 200 can include a remote host 104 connected to target host 102 via various computer networks and/or network segments. In the example of network environment 200, target host can be connected to Ethernet segment 202 whereas remote host 104 can be connected to Ethernet segment 204 and separated by various components of network environment 200, such as routers 206_T and 206_R (collectively routers 206). While for purposes of illustration, other network segments 208 is depicted generally, it is to be appreciated that any suitable network infrastructure can be used for initiating communications with target host 102 and for communicating information to remote host 104 from target host 102 and/or other components of network environment 200 to facilitate remote wake up of target host 102.

Thus, it is to be appreciated that, in addition to the network communications infrastructure described herein, for example with reference to FIGS. 1, 2, and 10, various modifications can be made to the disclosed network environments while keeping within the scope of the claims appended hereto. For purposes of illustration, other network segments 208 can include wireless links and other components (e.g., such as between a wireless access point 210 and wireless handheld device 212) in addition to wired links and components, as well as other components such as gateways, firewalls, switches, and/or servers (e.g., authentication, authorization, and/or accounting servers, file servers, web servers, database servers, etc.), and so on.

As described above with reference to network environment 100, target host 102 can be configured to use a wake up IP address (e.g., a separate IP address than that used for regular network traffic) to facilitate various aspects of the disclosed subject matter. For instance, prior to entering a sleep mode target host 102 can communicate the wake up IP address to resolution server 114. In another example, a remote host 104 that is trusted to remotely wake target host 102 (e.g., such as a remote desktop computer 214 on a different network segment, a wireless handheld device 212 over a wireless link, and/or server computer 216 on the same network segment, and the like) can receive the wakeup IP address of target host 102. In addition, target host 102 can be configured to facilitate communicating further information to components of network environment 200, such as wake up policy information, and so on.

In addition, prior to entering a sleep mode, a network device of target host 102 can be configured to recognize patterns of network traffic corresponding to attempts to resolve the wake up IP address of the target host 102. For example, target host 102 can update its associated network device to wake up target host 102 if it receives a network traffic pattern such as an ARP request or an IPv6 Neighbor Discovery request associated with the wake up IP address of the target host 102 and not for the regular IP address.

As a result, the disclosed subject matter can facilitate remotely waking a target host 102. For example, when a host (e.g., resolution server 114, remote host 104, wireless handheld device 212, remote desktop computer 214, server computer 216, and so on) desires sending traffic to target host 102, the host can determine or infer that target host 102 is in a sleep mode, either directly, or via one or more other components of network environment 200.

For example, in the event that remote host 104 attempts to initiate a new connection to target host 102, remote host can initiate a request (e.g., an http request). Remote host 104 can then attempt to resolve the target host 102 name to a network address such as an IP address for target host 102 via, for example, resolution server 114. Thus resolution server 114, can then resolve the name target host 102 to the regular IP address of target host 102, in the event that it is determined that target host 102 is not in a sleep mode. However, if resolution server 114 determines that target host 102 is in a sleep mode (e.g., from target host 102 communicating the wake up IP address prior to entering the sleep mode, after a predetermined connection timeout, or via one or more other components of network environment 200, etc.), then resolution server can send network traffic to the wake up IP address of target host 102. In addition, resolution server 114 can facilitate adhering to a wake up policy for target host 102 (e.g., by verifying that remote host 104 is trusted, only waking target host 102 according to predetermined policy constraints, or by verifying the authenticity of credentials for remote host 104, and so on) as described above in reference to network environment 100.

As a further example, the disclosed subject matter can facilitate trusting or authorizing a remote host (e.g., remote host 104, wireless handheld device 212, remote desktop computer 214, server computer 216, and so on) to remotely wake up target host 102. Thus, in the event that remote desktop computer 214 attempts to initiate a connection to target host 102, remote desktop computer 214 can send traffic to the regular IP address of target host 102 (e.g., on the basis of having already resolved and/or cached the regular IP address of target host 102), in the event that it is determined that target host 102 is not in a sleep mode. However, if remote desktop computer 214 determines that target host 102 is in a sleep mode (e.g., from target host 102 communicating the wake up IP address prior to entering the sleep mode, after a predetermined connection timeout, or via one or more other components of network environment 200, etc.), then remote desktop computer 214 can send network traffic to the wake up IP address of target host 102.

When network traffic is sent to the wake up IP address (e.g. via other network segments 208, router 206, and/or network segment 202, and so on), target host 102 can be configured to resume from sleep mode if it receives a network traffic pattern directed associated with the wake up IP address (e.g., an ARP request or an IPv6 Neighbor Discovery request for the target host 102 wake up IP address) and to ignore traffic patterns to the regular IP address.

For example, if remote host 104 sends a packet to target host 102 at its wake up IP address, but remote host 104 does not know the MAC address of target host 102, then an ARP request can be generated to discover target host 102 MAC address. For instance, if target host 102 and remote host are on the same network segment (e.g., as for the network segment 202 connecting target host 102 and server computer 216), then remote host (e.g., server computer 216 in this case) can facilitate sending an ARP request to discover target host 102 MAC address.

In the event that target host 102 and a remote host are not on the same network segment (e.g., as for target host 102 on network segment 202 connected to remote host 104 via network segment 204 separated at least by routers 206), then remote host 104 can facilitate sending IP packets to target host 102 via routers 206_R and 206_T and destined for the wake up IP address associated with target host 102. As a result, router 206_R could then look up target host 102 in its routing table to determine the IP address of the appropriate router (e.g., any in other network segments 208). If router 206_R does not already know the MAC address of that router, the router 206_R could send an ARP request to determine that MAC address. This process can repeat until router 206_T receives the IP packets from remote host 104. In turn, router 206_T could then look up the MAC address of target host 102 for the wakeup IP address in its ARP cache entries.

Thus, in the event that router 206_T does not find the MAC address of target host 102 for the wakeup IP address in its ARP cache entries, the router 206_T could send an ARP request to discover the target host 102 MAC address. This ARP request is typically broadcast over the local network segment (e.g., network segment 202). As a result, target host 102 could receive an ARP request associated with its wake up IP address, and according to an aspect of the disclosed subject matter, can facilitate waking up target host 102 from a sleep mode. It should be understood that if target host 102 were running and available using its regular IP address (or set of IP addresses), then it could still receive the ARP request and not send an ARP reply packet.

It should be further understood that router 206_T typically would not already have ARP cache entries with the MAC address associated with the target host 102 wake up IP address, because, according to an aspect of the disclosed subject matter, a wake up IP address can be limited to usage for wake up requests. In addition, any hosts on the same network (e.g., network segment 202) as target host 102 would also see the ARP request (since it is a broadcast). Thus, although other hosts are able to cache information about the source of the ARP request, the ARP reply (if any) is typically directed to the originator of the ARP request (e.g., router 206_T. As a result, information in any ARP reply is not available to other hosts on the same network.

In addition, according to a further aspect of the disclosed subject matter, rather than sending an ARP reply in response to receiving an ARP request at the wake up IP address, the target host 102 can be configured to wake up (e.g., resume) from a sleep mode. Thus the ARP request, in one aspect of the disclosed subject matter, can simply be ignored from the standpoint of resolving the ARP request and caching entries. Furthermore, once target host 102 resumes from a sleep mode, according to a further aspect of the disclosed subject matter, the target host can acquire a new regular IP address (or set of regular IP addresses), resume using a previously used regular IP address (or set of regular IP addresses), or any combination thereof, so long as the wake up IP address is limited to receiving wake up traffic at target host 102. As a result, once a target host 102 has resumed from a sleep mode, any wake up IP address to MAC address pair of target host 102 cached in an ARP entry would no longer be valid.

However, in the event that any ARP request results in target host 102 wake up IP address being resolved and associated with its MAC address in ARP cache entries of a router 206, such ARP cache entries would be dynamic and subject to expiration (e.g., the entries can expire after a predetermined timeout period and/or event). In the unlikely event that target host 102 returns to a sleep mode and the target host 102 wake up IP address is still resolved and associated with its MAC address in the ARP cache entries of a router 206, according to one aspect of the disclosed subject matter, the target host can be configured to ignore traffic resulting from the condition. According to a further aspect of the disclosed subject matter, the target host 102 can be configured to respond to the traffic resulting from the condition (e.g., such as by generating a wake up signal to resume from the sleep mode).

It should be appreciated that, although aspects of various embodiments of the disclosed subject matter are described with particularity with respect to the components of network environment 200 and in connection with recognizing an ARP request to a wake up IP address as wakeup traffic, the disclosed subject matter is not so limited. Thus, one having ordinary skill in the art would recognize that various modifications could be made without departing from the spirit of the disclosed subject matter. Thus, it should be understood that the description herein is but one of many embodiments that may be possible while keeping within the scope of the claims appended hereto.

The following sections provide additional details regarding particular non-limiting embodiments of the components and functionality of network environments 100 and 200 for the purpose of illustration and not limitation. Thus, it is to be appreciated that the description herein is but one of many embodiments that may be possible while keeping within the scope of the claims appended hereto.

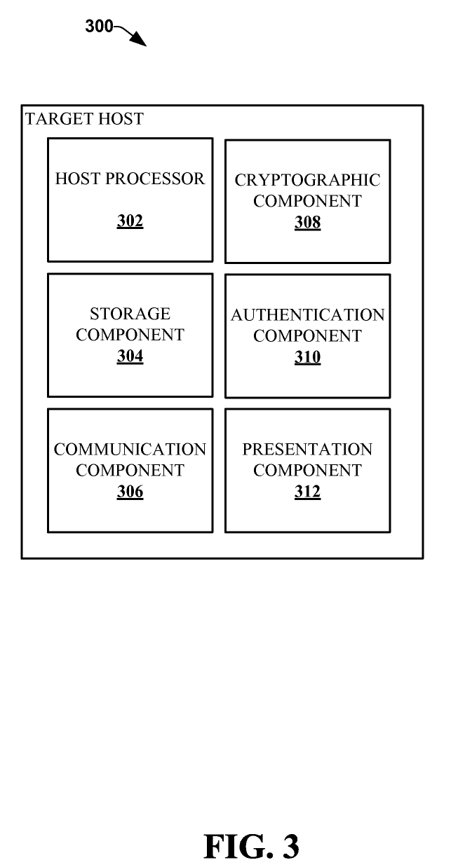

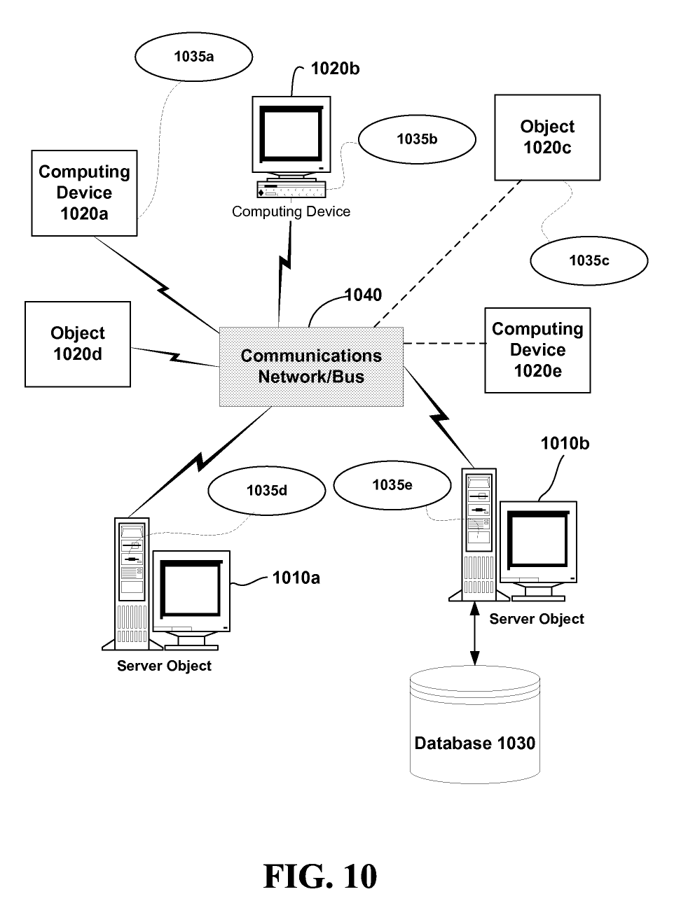

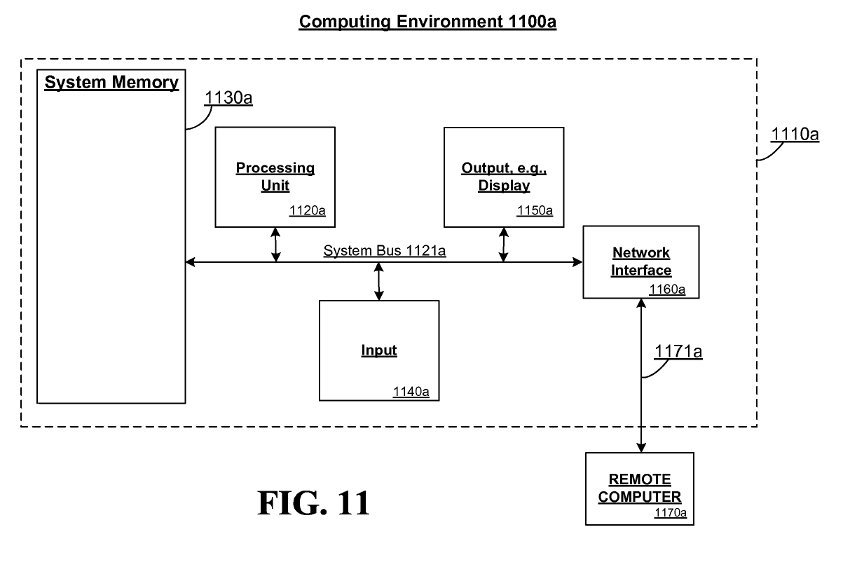

FIG. 3 illustrates an exemplary non-limiting block diagram of a target host system 300 that facilitates efficient and transparent remote wakeup according to various embodiments of the disclosed subject matter. It is to be appreciated that while some of the functionality of target host system 300 is described in a general context, more or less of the described functionality may be implemented, combined, and/or distributed (e.g., among target and remote hosts, resolution servers, other servers and databases, network equipment such as routers and firewalls, and the like) according to context, system design considerations, and/or marketing factors, and the like. Thus, as described above and as further described below (e.g., in connection with FIGS. 10 and 11), in various non-limiting embodiments of the disclosed subject matter, target host system 300 can include host processor 302 and storage component 304.

In various non-limiting embodiments of the disclosed subject matter, host processor 302 can be associated with a storage component 304 to facilitate storage of data and/or instructions to facilitate performing functions associated with, and incident to, the disclosed subject matter. In addition to the functions described above with reference to FIGS. 1-2, host processor 302 can, for example, execute operating system instructions, device driver code (e.g., network device driver code), middleware, applications, and/or other software routines and instructions to facilitate placing target host system 300 in a sleep mode, setting wake up traffic patterns in a network device of host system 300, waking target host system 300 upon receiving proper wake up traffic to a wake up address, communicating a wake up address to other components of a network environment, composing and setting a wake up policy that can be communicated to other components of a network environment, and so on, in addition to other functions necessary or ancillary to various aspects of the disclosed subject matter.

In addition, host processor 302 can be associated with communication component 306 to facilitate performing functions associated with, and incident to, the disclosed subject matter. For example, in addition to various low-level and high-level functions associated with communicating over an attached network and those functions described above with reference to FIGS. 1 and 2, communications component 306 can facilitate receiving network traffic, recognizing network traffic as a proper wakeup traffic associated with a wake up address, responding to network traffic to resume target host system 300 from a sleep mode, carrying on normal network communications over a regular address once target host system is restored from a sleep mode, communicating a wake up address to other components of a network environment, communicating a wake up policy to other components of a network environment, and so on.

Additionally, host processor 302 can be associated with a cryptographic component 308. In accordance with an aspect of the disclosed subject matter, cryptographic component 308 can provide symmetric cryptographic tools and accelerators (e.g., Twofish, Blowfish, AES, TDES, IDEA, CAST5, RC4, etc.) to facilitate encrypting and/or decrypting data. Thus, cryptographic component 308 can facilitate securing data being written to, stored in, and/or read from the storage component 304, transmitted to or received from a connected network, and/or creating a secure communication channel as part of a secure association of target host system 300 with an entity (e.g., a user, a device, a component, and/or a subcomponent, and so on) to facilitate protecting data and/or instructions to restrict access to those entities authorized and/or authenticated to do so.

For example, to facilitate restricting and permitting remote wake up capability to only those authorized or trusted entities, the disclosed subject matter, in one aspect thereof, can facilitate encrypting and/or decrypting data and/or instructions to limit access to those authorized and/or trusted entities. As a further example, the disclosed subject matter facilitates encrypting information (e.g., a target host wake up address, wake up policy, etc.) prior to sending such information to an entity that is determined to be trustworthy. To the same ends, cryptographic component 308 can also provide asymmetric cryptographic accelerators and tools (e.g., RSA, Digital Signature Standard (DSS), and the like) in addition to accelerators and tools (e.g., Secure Hash Algorithm (SHA) and its variants such as, for example, SHA-0, SHA-1, SHA-224, SHA-256, SHA-384, and SHA-512).

Target host 300 can further include an authentication component 310 that can solicit authentication data from and/or provide authentication data to an entity (e.g., a user, a device, a component, and/or a subcomponent, and so on) or another object (e.g., an operating system and/or application software) on behalf of an entity, and, upon receiving the proper authentication data so solicited, can be employed, individually and/or in conjunction with information acquired and ascertained as a result of biometric modalities employed, to facilitate authentication of the entity to permit, limit, and/or restrict remote wake up of target host system 300.

For example, prior to entering a sleep mode, authentication component 310 can facilitate authenticating an entity based on information provided (e.g., from a remote host, from synching with a device in proximity and/or in communication with target host system 300, and/or via a proxy and/or a trusted third party, and so on). For instance, authentication data can be in the form of a password (e.g., a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g., Personal Identification Number (PIN)), and the like, for example. Additionally and/or alternatively, public key infrastructure (PKI) data can also be employed by authentication component 310. PKI arrangements can provide for trusted third parties to vet, and affirm, entity identity through the use of public keys that typically can be certificates issued by trusted third parties. Such arrangements can enable entities to be authenticated to each other, and to use information in certificates (e.g., public keys) and private keys, session keys, Traffic Encryption Keys (TEKs), cryptographic-system-specific keys, and/or other keys, to encrypt and decrypt messages communicated between entities.

The authentication component 310 can implement one or more machine-implemented techniques to identify an entity (e.g., a user, a device, a component, and/or a subcomponent, and so on) or another object (e.g., an operating system and/or application software) on behalf of an entity, by an entity's unique physical and/or behavioral characteristics and attributes. For example, in the case of user authentication, biometric modalities that can be employed can include, for example, face recognition wherein measurements of key points on an entity's face can provide a unique pattern that can be associated with the entity, iris recognition that measures from the outer edge towards the pupil the patterns associated with the colored part of the eye—the iris—to detect unique features associated with an entity's iris, and finger print identification that scans the corrugated ridges of skin that are non-continuous and form a pattern that can provide distinguishing features to identify an entity.

Referring again to FIG. 3, target host 300 can also include a presentation component 312, which can be associated with the host processor 302, and which can facilitate efficient and transparent remote wake up. For example, the presentation component 312 can provide various types of user interfaces to facilitate interaction between a user and any component coupled to the host processor 302. In addition, presentation component 312 can provide one or more graphical user interfaces (GUIs), command line interfaces, structured and/or customized menus, and the like. For example, a GUI can be rendered that provides a user with a region or means to load, import, read, etc., data, and can include a region to present such results. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled to and/or incorporated into host processor 302.

The user can also interact with the regions to select and provide information via various devices such as a mouse, a roller ball, a keypad, a keyboard, touchpad, touch screen, a pen and/or voice activation, for example. Typically, a mechanism such as a push button or the enter key on the keyboard can be employed to facilitate entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards of a computer) and/or displays (e.g., black and white, EGA, or other video display unit of a standalone device such as an LCD display on a network printer) with limited graphic support, and/or low bandwidth communication channels.

As depicted, target host system 300 is described as a monolithic system. However, it is to be appreciated that the various components and/or the functionality provided thereby can be incorporated into the host processor 302 and/or provided by other connected devices and systems. Accordingly, it is to be appreciated that more or less of the described functionality may be implemented, combined, and/or distributed (e.g., among network devices, servers, databases, and the like), according to context, system design considerations, and/or marketing factors.

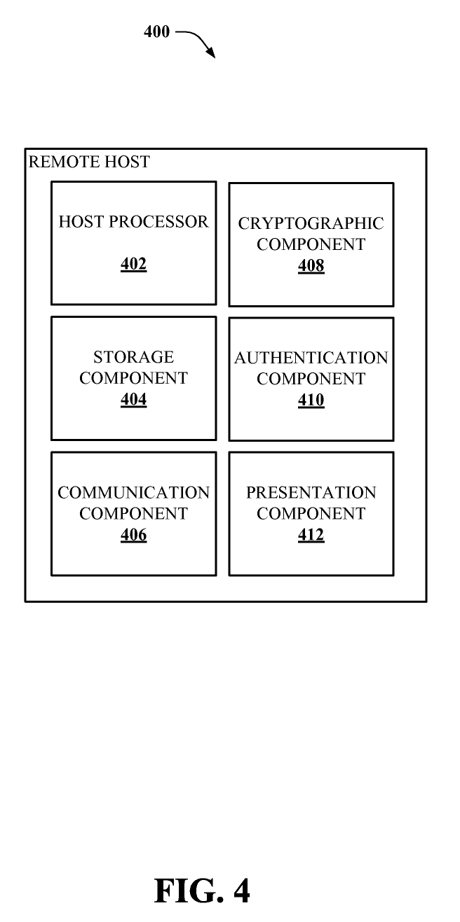

FIG. 4 illustrates an exemplary non-limiting block diagram of a remote host system 400 that facilitates efficient and transparent remote wakeup according to various embodiments of the disclosed subject matter. It is to be appreciated that while some of the functionality of remote host system 400 is described in a general context, more or less of the described functionality may be implemented, combined, and/or distributed (e.g., among target and remote hosts, resolution servers, other servers and databases, network equipment such as routers and firewalls, and the like) according to context, system design considerations, and/or marketing factors, and the like. In addition, it is to be further appreciated that, in many cases, remote host system 400 can share many of the same types of components, perform the same or similar functions, or can be both a remote host in addition to a target host, depending on the context. Thus, as described above and as further described below (e.g., in connection with FIGS. 10 and 11), in various non-limiting embodiments of the disclosed subject matter, remote host system 400 can include host processor 402 and storage component 404.

In various non-limiting embodiments of the disclosed subject matter, host processor 402 can be associated with a storage component 404 to facilitate storage of data and/or instructions to facilitate performing functions associated with, and incident to, the disclosed subject matter. In addition to the functions described above with reference to FIGS. 1-3, host processor 402 can, for example, execute operating system instructions, device driver code (e.g., network device driver code), middleware, applications, and/or other software routines and instructions to facilitate communicating with a target host (e.g., target host system 300) to facilitate receiving a wake up address and wake up policy information, determining whether a target host is in a sleep mode, sending traffic to a wake up address associated with a target host to facilitate remotely waking the target host, and so on, in addition to other functions necessary or ancillary to various aspects of the disclosed subject matter.

In addition, host processor 402 can be associated with communication component 406 to facilitate performing functions associated with, and incident to, the disclosed subject matter. For example, in addition to various low-level and high-level functions associated with communicating over an attached network and those functions described above with reference to FIGS. 1-3, communications component 406 can facilitate receiving a wake up address and/or wake up policy information from or on behalf of a target host, sending traffic to a wake up address associated with a target host to facilitate remotely waking the target host, carrying on normal network communications over a regular address once target host system is restored from a sleep mode, communicating authentication information to a target host and/or other components of a network environment, and so on.

Additionally, host processor 402 can be associated with a cryptographic component 408 in accordance with an aspect of the disclosed subject matter. As described above, cryptographic component 408 can provide cryptographic tools and accelerators to facilitate encrypting and/or decrypting data. Thus, cryptographic component 408 can facilitate securing data being written to, stored in, and/or read from the storage component 404, transmitted to or received from a connected network, and/or creating a secure communication channel as part of a secure association of remote host system 400 with an entity (e.g., target host system 300, and/or other components and/or subcomponents of a network environment, and so on) to facilitate protecting data and/or instructions to restrict access to those entities authorized and/or authenticated to do so.

For example, to facilitate restricting and permitting remote wake up capability to only those authorized or trusted entities, the disclosed subject matter, in one aspect thereof, can facilitate decrypting and/or encrypting data, instructions, and so on, to facilitate limiting access to those authorized or trusted entities. As a further example, the disclosed subject matter facilitates decrypting encrypted information (e.g., a target host wake up address, wake up policy, etc.) after receiving such encrypted information from a target host (e.g., directly or on behalf of a target host via another component of a network environment).

Remote host system 400 can further include an authentication component 410 that can provide authentication data to and/or solicit authentication data from an entity (e.g., a user, a device, a component, and/or a subcomponent, and so on) or another object (e.g., an operating system and/or application software) on behalf of an entity, and, upon providing the proper authentication data, can be employed, individually and/or in conjunction with information desired from biometric modalities employed, to facilitate authentication of the entity to permit, limit, and/or restrict remote wake up of target host system 300. For example, prior to entering a sleep mode, authentication component 410 can facilitate authenticating remote host system 400 based on information provided to and/or for the benefit of a target host system 300 (e.g., from a remote host, from synching with a device in proximity and/or in communication with target host system 300, and/or via a proxy and/or a trusted third party, and so on).

In addition, according to various non-limiting embodiments of the disclosed subject matter, remote host system can include a presentation component 412 such as that describe above in connection with presentation component 312.

As depicted, remote host system 400 is described as a monolithic system. However, it is to be appreciated that the various components and/or the functionality provided thereby can be incorporated into the host processor 402 or provided by other connected devices and systems. Accordingly, it is to be appreciated that more or less of the described functionality may be implemented, combined, and/or distributed (e.g., among network devices, servers, databases, and the like), according to context, system design considerations, and/or marketing factors.

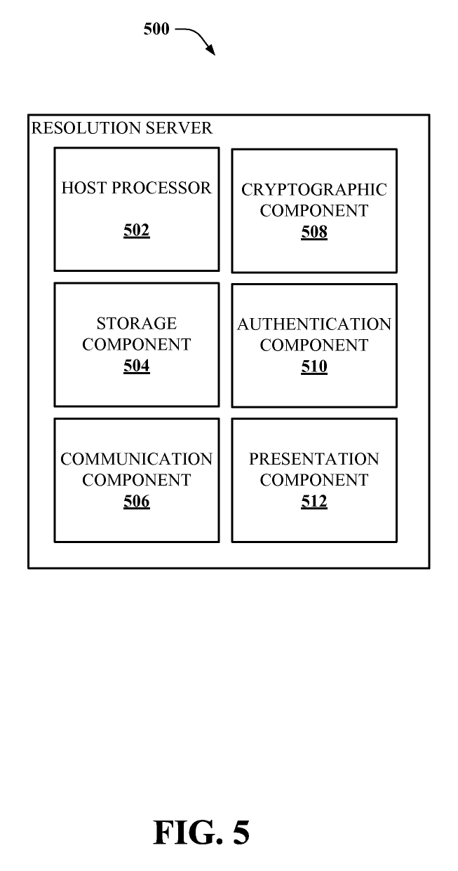

FIG. 5 illustrates an exemplary non-limiting block diagram of a resolution system 500 that facilitates efficient and transparent remote wakeup according to various embodiments of the disclosed subject matter. It is to be appreciated that while some of the functionality of resolution system 500 is described in a general context, more or less of the described functionality may be implemented, combined, and/or distributed (e.g., among target and remote hosts, resolution servers, other servers and databases, network equipment such as routers and firewalls, and the like) according to context, system design considerations, and/or marketing factors, and the like. In addition, it is to be further appreciated that, in many cases, resolution system 500 can share many of the same types of components, perform a set of the same and/or similar functions of a remote host in addition to a target host, depending on the context. Thus, as described above and as further described below (e.g., in connection with FIGS. 10 and 11), in various non-limiting embodiments of the disclosed subject matter, resolution system 500 can include host processor 502 and storage component 504.

In various non-limiting embodiments of the disclosed subject matter, host processor 502 can be associated with a storage component 504 to facilitate storage of data and/or instructions to facilitate performing functions associated with, and incident to, the disclosed subject matter. In addition to the functions described above with reference to FIGS. 1-4, host processor 502 can, for example, execute operating system instructions, device driver code (e.g., network device driver code), middleware, applications, and/or other software routines and instructions to facilitate communicating with a target host (e.g., target host system 300) to facilitate receiving a wake up address and wake up policy information, determining whether a target host is in a sleep mode, sending traffic to a target host wake up address to facilitate remotely waking the target host, resolving and/or publishing a target host regular address and/or a wake up address (e.g., according to a resolution protocol such as a DNS protocol and/or a resolution protocol as described herein), authenticating remote hosts to limit and/or restrict access of remote hosts to wake up of target hosts, and so on, in addition to other functions necessary or ancillary to various aspects of the disclosed subject matter.

In addition, host processor 502 can be associated with communication component 506 to facilitate performing functions associated with, and incident to, the disclosed subject matter. For example, in addition to various low-level and high-level functions associated with communicating over an attached network and those functions described above with reference to FIGS. 1-4, communications component 506 can facilitate receiving a wake up address and/or wake up policy information from or on behalf of a target host, sending traffic to a wake up address associated with a target host to facilitate remotely waking the target host, resolving and/or publishing a target host regular address and/or a wake up address (e.g., according to a resolution protocol such as a DNS protocol and/or a resolution protocol as described herein), communicating authentication information and/or a wake up address to other components of a network environment, and so on.

Additionally, host processor 502 can be associated with a cryptographic component 508 in accordance with an aspect of the disclosed subject matter. As described above, cryptographic component 508 can provide cryptographic tools and accelerators to facilitate encrypting and/or decrypting data. Thus, cryptographic component 308 can facilitate securing data being written to, stored in, and/or read from the storage component 304, transmitted to or received from a connected network, and/or creating a secure communication channel as part of a secure association of resolution system 500 with an entity (e.g., target host system 300, and/or other components and/or subcomponents of a network environment such as remote host system 400, and so on) to facilitate protecting data and/or instructions that can only be accessed by those entities authorized and/or authenticated to do so.

For example, to facilitate restricting and permitting remote wake up capability to only those authorized or trusted entities, the disclosed subject matter, in one aspect thereof, can facilitate decrypting and/or encrypting data, instructions, and so on, to facilitate limiting access to those authorized or trusted entities. As a further example, the disclosed subject matter facilitates encrypting and/or decrypting encrypted information (e.g., a target host wake up address, wake up policy, etc.) after receiving such encrypted information from a target host (e.g., directly or via another component of a network environment) or to facilitate providing such information in encrypted form on behalf of a target host system 300.

Resolution system 500 can further include an authentication component 510 that can solicit authentication data from and/or provide authentication data to an entity (e.g., a user, a device, a component, and/or a subcomponent, and so on) or another object (e.g., an operating system and/or application software) on behalf of an entity, and, upon receiving or providing the proper authentication data, can be employed, individually and/or in conjunction with information desired or ascertained as a result of biometric modalities employed, to facilitate authentication of the entity to permit, limit, and/or restrict remote wake up of target host system 300.

For example, prior to a target host system entering a sleep mode, authentication component 510 can facilitate authenticating resolution system 500 based on information solicited for the benefit of and/or provided to a target host system 300 (e.g., from a remote host, from a device in communication with target host system 300, and/or via a proxy and/or a trusted third party, and so on). As a further example, authentication component 510 can facilitate authenticating remote host system 400 based on information solicited for the benefit of target host system 300 (e.g., from a remote host, and/or via a proxy and/or a trusted third party, and so on).

In addition, according to various non-limiting embodiments of the disclosed subject matter, remote host system can include a presentation component 412 such as that describe above in connection with presentation component 312.

As depicted, resolution system 500 is described as a monolithic system. However, it is to be appreciated that the various components and/or the functionality provided thereby can be incorporated into the host processor 502 or provided by other connected devices and systems. Accordingly, it is to be appreciated that more or less of the described functionality may be implemented, combined, and/or distributed (e.g., among network devices, servers, databases, and the like), according to context, system design considerations, and/or marketing factors.

In view of the exemplary systems and devices described supra, methodologies that can be implemented in accordance with the disclosed subject matter will be better appreciated with reference to the flowcharts of FIGS. 5-8. While for purposes of simplicity of explanation, the communication processes and methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, can be implemented which achieve the same or a similar result. Moreover, not all illustrated blocks may be required to implement the methodologies described hereinafter.

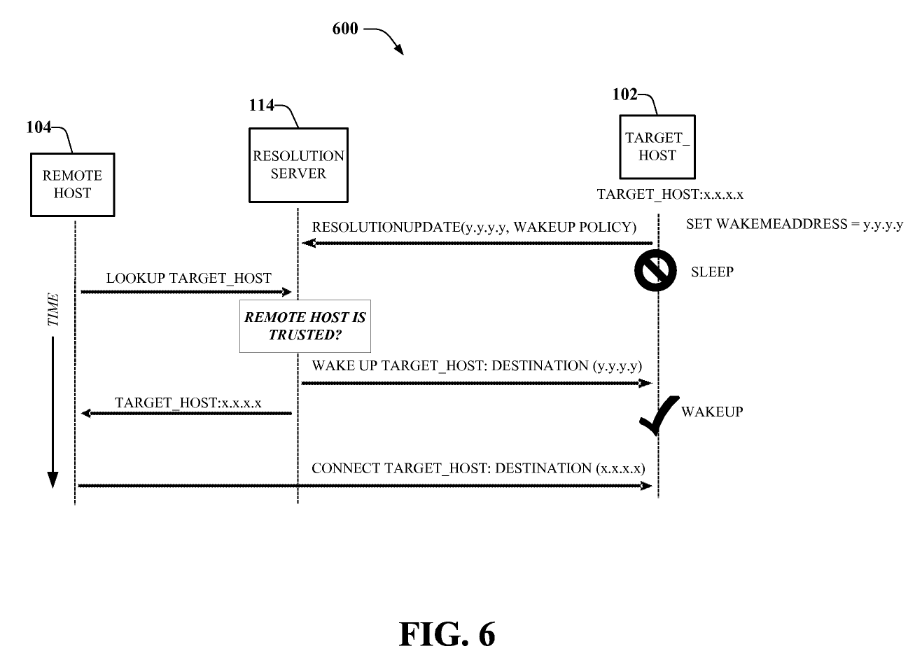

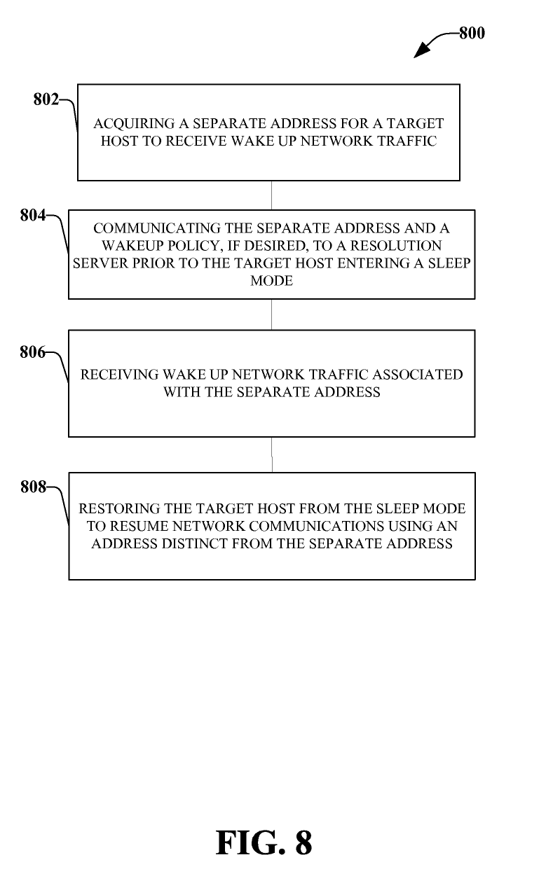

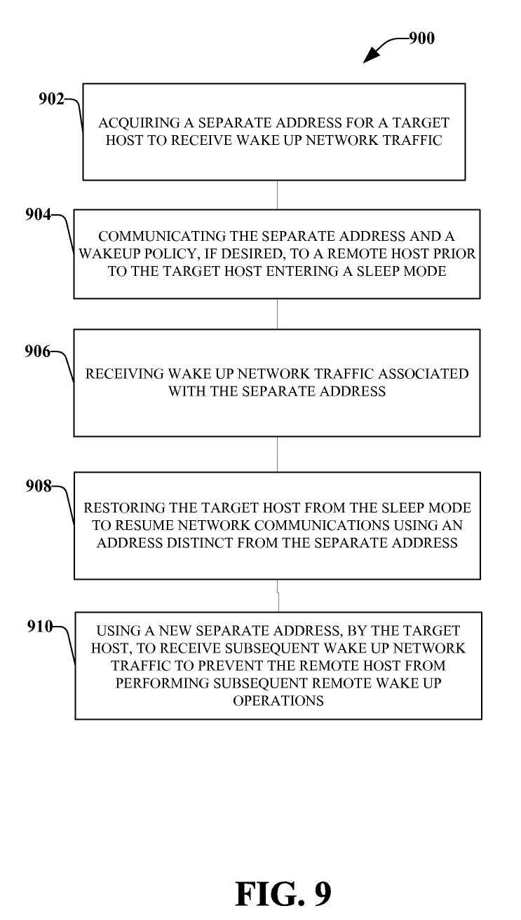

FIG. 6 depicts a timing diagram of an exemplary non-limiting communication process 600 for remote wake up of a target host according to various embodiments of the disclosed subject matter. Thus, as described above and as further described below (e.g., in connection with FIGS. 8 and 9), in various non-limiting embodiments of the disclosed subject matter, communication process 600 can comprise target host 102 in communication with remote host 104 and resolution server 114, for example in connection with exemplary network environment 100.

According to various embodiments of the disclosed subject matter, communication process 600 can facilitate transparent remote wake up of target host 102 by a remote host 104. For example, the communication process 600 can facilitate transparent remote wake up of target host 102 by a remote host 104 that can be authorized to perform remote wake up of target host (e.g., directly from target host 102 and/or on behalf of target host 102 via a proxy and/or a trusted third party, and so on). As a further example, remote host 104 can be a remote host that target host 102 was not in communication with prior to target host entering a sleep mode, a remote host that has not previously established a trusted relation with target host 102, and/or a remote host that has previously established a trusted relation with target host 102 via a proxy and/or a trusted third party (e.g., resolution server 114), and so on, such that remote host 104 resolution of target host 102 is performed prior to communicating with target host 102. For the purposes of illustration, and not limitation, such classes of communication processes can be referred to as new connections to target host 102.

Accordingly, resolution server 114 can include, for example, a resolution system 500, which can be a DNS server (e.g., as modified according to various aspects of the disclosed subject matter) to facilitate establishing new connections to target host 102. Thus, prior to target host 102 entering a sleep mode, target host 102, or an entity on behalf of target host 102, can send an associated wakemeaddress (e.g., y.y.y.y) in a resolution update to resolution server 114 (e.g., such as by using a DNS update to an authoritative DNS server, by using a Mobile IP binding update, and so on). The resolution server 114 (e.g., a modified DNS server) can also receive and include a remote wake up policy as described above, for example, that can identify remote hosts that are allowed to remotely wake target host 102 and can set other limitations regarding remote wake up of target host 102.

When the resolution server 114 (e.g., a modified DNS server) receives a name resolution request (e.g., lookup TARGET_HOST) for target host 102 from an authorized host (e.g. a new remote host 104 where a wake up policy is permissive, and/or a trusted remote host 112), resolution server 114 can facilitate remotely waking target host 102 in that the event that, for example, remote host 104 is determined to be an authorized and/or trusted remote host. For example, resolution server 114 (e.g., a modified DNS server) can send a packet to target host 102 via the wakemeaddress associated with target host 102 (e.g., WAKE UP TARGET_HOST: DESTINATION (y.y.y.y)) and can respond to the name resolution request by remote host 104 by sending a regular address associated with target host 102 (e.g., TARGET_HOST:x.x.x.x). Accordingly, network traffic received at target host 102 (e.g., an ARP request traffic associated with wakemeaddress (y.y.y.y) and/or other predetermined traffic patterns) can be recognized by the network device of target host 102 and can facilitate restoring target host 102 from a sleep mode (e.g., remotely waking target host 102).

As a result, once target host 102 has restored from its sleep mode, including but not limited restoring its regular address (e.g., x.x.x.x), target host 102 will be able to communicate with the remote host 104 via the regular address (e.g., x.x.x.x) associated with target host 102. In the event that resolution server 114 determines that remote host 104 cannot be trusted or authenticated (e.g., directly from target host 102 and/or on behalf of target host 102 via a proxy and/or a trusted third party, and so on), such lack of authority or trusted relation can facilitate denying remote host 104 the ability to remotely wake target host 102, for example, by ignoring the resolution request, refusing to send wake up traffic to the wakemeaddress associated with target host 102, and so on.

Advantageously, according to various embodiments of the disclosed subject matter, resolution server 114 can facilitate remote wake up of target host for all legacy remote hosts, depending on whether a remote host can be trusted or authenticated. In other words, assuming that the connection from the remote host does not time out before target host 102 resumes from a sleep mode, the remote wake up operation can be transparent from the legacy host's point of view. In addition, once a remote host 104 connects to target host 102 (e.g., via a regular address associate with target host 102), the disclosed subject matter, in one aspect thereof, can facilitate authorizing the remote host 104 to perform remote wake up. For example, target host 102 can provide information (e.g., directly from target host 102 and/or on behalf of target host 102 via a proxy and/or a trusted third party, and so on) to the resolution server 114 to facilitate authentication, and for the purpose of providing limited access to remote wake up of target host 102. As a further example, such information can include a cookie to be set on a browser client of remote host 104, a certificate provided to remote host 104, and/or other credentials, and so on, to facilitate determining the trust or authentication status of remote host 104 by resolution server 114.

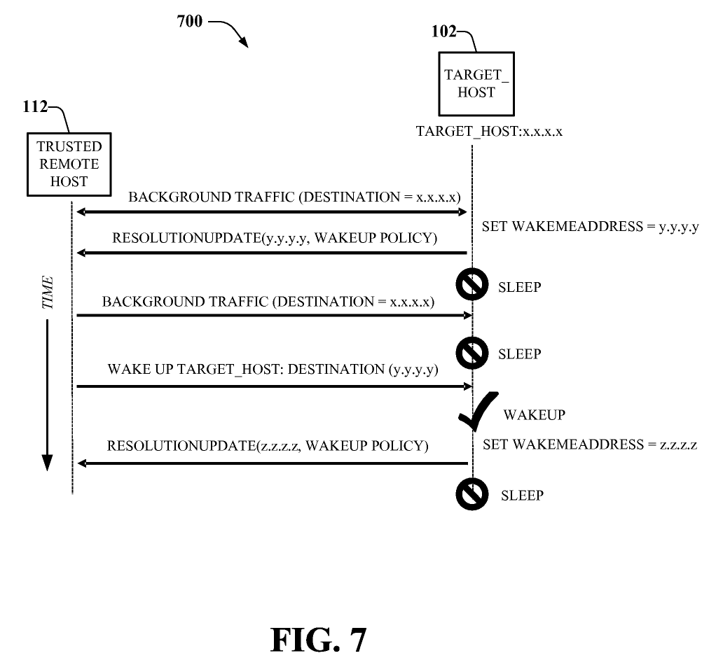

FIG. 7 depicts a timing diagram of an exemplary non-limiting communication process for remote wake up of a target host according to further embodiments of the disclosed subject matter. Thus, as described above and as further described below (e.g., in connection with FIGS. 8 and 9), in various non-limiting embodiments of the disclosed subject matter, communication process 700 can comprise target host 102 in communication with a trusted remote host 112, for example in connection with exemplary network environment 100. According to various embodiments of the disclosed subject matter, communication process 700 can facilitate transparent remote wake up of target host 102 from a trusted remote host 112. For example, the communication process 700 can facilitate transparent remote wake up of target host 102 from a trusted remote host 112, which can be authorized to perform remote wake up of target host 102 (e.g., authorized directly from target host 102 and/or on behalf of target host 102 via a proxy and/or a trusted third party, and so on).

Advantageously, various embodiments of the disclosed subject matter can facilitate remote wake up of target host 102 depending on whether a remote host can be trusted or authenticated. For example, once a remote host 104 (not shown) connects to target host 102 (e.g., via a regular address associate with target host 102), the disclosed subject matter, in one aspect thereof, can facilitate authorizing the remote host 104 to perform remote wake up. For example, target host 102 can provide information (e.g., directly from target host 102 and/or on behalf of target host 102 via a proxy and/or a trusted third party, and so on) to a remote host 104 (not shown) to facilitate authentication (e.g., via a proxy and/or a trusted third party, and so on)), and for the purpose of providing limited access to remote wake up of target host 102.

Although in particular non-limiting embodiments of the disclosed subject matter, target host 102 can directly decide whether remote host 104 (not shown) is authentic or can be trusted, it should be appreciated that in further non-limiting embodiments of the disclosed subject matter, such a decision can be facilitated on behalf of target host 102 via a proxy and/or a trusted third party, and so on. For example, the decision by a target host 102 can result in limited disclosure of a wakemeaddress and/or wake up policy information to remote host 104 (not shown), As a further example, such information provided can include a cookie to be set on a browser client of remote host 104 (not shown), a certificate provided to remote host 104 (not shown), and/or other credentials delivered to remote host (not shown) to facilitate determining the trust or authentication status of remote host 104 (not shown) on behalf of target host 102 via a proxy and/or a trusted third party, and so on. As a further example, such a proxy or trusted third party can include other network components, such as an authentication server component of an AAA server. Once a remote host 104 has been authenticated or has been trusted, remote host can be said to be a trusted remote host (e.g. trusted remote host 112).

Accordingly, trusted remote host 112 can be a remote host that target host 102 was in communication with prior to target host 102 entering a sleep mode, and/or which established a trusted relation with target host 102, and so on such that trusted remote host does not necessarily require resolution of target host 102 prior to communicating with target host 102. Thus, background traffic (e.g., BACKGROUND TRAFFIC (DESTINATION=x.x.x.x)) can exist on connections to target host 102 via a regular address associated with target host 102 (e.g., TARGET_HOST:x.x.x.x). In addition, prior to target host 102 entering a sleep mode, target host 102, or an entity on behalf of target host 102, can send an associated wakemeaddress (e.g., y.y.y.y) in a resolution update to trusted remote host 112. The trusted remote host 112 can also receive and include a remote wake up policy as described above, for example, that can set limitations regarding remote wake up of target host 102. Advantageously, the disclosed subject matter can facilitate target host remaining in sleep mode even in the event of continuing background traffic (e.g., BACKGROUND TRAFFIC (DESTINATION=x.x.x.x)) to a regular address associated with target host 102.

When the trusted remote host 112 (e.g., a remote host system 400) desires to reestablish communications with target host 102, it can facilitate remotely waking target host 102. For example, trusted remote host 112 can send a packet to target host 102 via the wakemeaddress associated with target host 102 (e.g., WAKE UP TARGET_HOST: DESTINATION (y.y.y.y)). Accordingly, network traffic received at target host (e.g., an ARP request traffic associated with wakemeaddress (y.y.y.y) and/or other predetermined traffic patterns) can be recognized by the network device of target host 102 and can facilitate restoring target host 102 from a sleep mode (e.g., remotely waking target host 102).

As a result, once target host 102 has restored from its sleep mode, including but not limited restoring its regular address (e.g., x.x.x.x), target host 102 will be able to communicate with trusted remote host 112 via target hosts regular address (e.g., by communicating a resolution update to trusted remote host 112 to facilitate expiring the wakemeaddress and use the regular address x.x.x.x). As a result, communications from trusted remote host 112 (as well as any other hosts) can continue using the regular address (e.g., x.x.x.x) and the wakemeaddress (e.g., y.y.y.y) can be released.

Advantageously, in the event that target host 102 determines that remote host 104 (not shown) cannot be trusted or authenticated (e.g., directly from target host 102 and/or on behalf of target host 102 via a proxy and/or a trusted third party, and so on), such lack of authority or trust can facilitate denying the remote host 104 (not shown) the ability to remotely wake target host 102 (e.g., by not disclosing a wake up address associated with target host 102). As a further advantage, in the event that target host determines that formerly trusted remote host (not shown) cannot be trusted any longer and/or that its authentication credentials have expired (e.g., determined directly by target host 102 and/or on behalf of target host 102 via a proxy and/or a trusted third party, and so on), such lack of authority or trust can facilitate denying the formerly trusted remote host (not shown) the ability to remotely wake target host 102.

For example, a formerly trusted remote host (not shown) can be denied access to remote wake up capabilities for target host 102, by setting a new wakemeaddress prior to the next time target host 102 enters a sleep mode. As further example, prior to entering a sleep mode, target host 102 can set a new wakemeaddress (SET WAKEMEADDRESS=z.z.z.z) that can be communicated to the formerly and presently trusted remote host 112, while denying such information to a formerly trusted remote host (not shown). As a result, the ability of a formerly trusted remote host (not shown) to remotely wake target host can be revoked.

FIG. 8 illustrates a particular non-limiting high-level methodology that facilitates efficient and transparent remote wakeup of a target host according to various aspects of the disclosed subject matter. At 802, a separate address to receive wake up network traffic can be acquired by the target host (e.g., target host 102, target host system 300, etc.). For example, a normal IP address of a target host can be used for normal network traffic while the target host is operating. A separate IP address so acquired can be reserved for receiving wake up network traffic according to various aspects of the disclosed subject matter. As a further example, such wake up network traffic can include, for example, an address resolution protocol (ARP) request associated with the separate address, and/or an internet protocol version six (IPv6) neighbor discovery request associated with the separate address, and so on.

In addition, at 804, the separate address can be communicated to a resolution server (e.g., resolution server 114 or 500, a modified DNS server, etc.) prior to the target host entering a sleep mode. For example, prior to entering a low power and low availability state (e.g., a standby mode or sleep mode), the target host can send the separate IP address to a resolution server (e.g., a DNS server) according to aspects of the disclosed subject matter. Moreover, at 804 a wake up policy can be communicated to the resolution server, if desired. For example, a wake up policy can include restrictions on remote wake up operations based on such distinctions as described above (e.g., a time-based distinction, a network information based distinction, an application-based distinction, a user identity-based distinction, a host identity-based distinction, an event-based distinction, a state-based distinction, or a geographic related distinction). Additionally, a secure communication channel can be established with the resolution server for securely communicating the separate address and/or the wake up policy.

At 806, wake up network traffic associated with the separate address can be received by the target host. As an example, a target host can configure an associated network device to recognize patterns of network traffic as wake up network traffic. In addition, based on a determination of whether a host requesting resolution of the target host can be trusted or according to a wake up policy, the wake up network traffic can be received from the resolution server. For example, the determination of whether the host requesting resolution of the target host can be trusted can be performed in part by an authentication component of the resolution server (e.g., directly or via a proxy or trusted third party entity).

Additionally, at 808 the target host can be restored from the sleep mode to resume network communications using an address distinct from the separate address. For example, upon resuming from a sleep mode, the target host can communicate the distinct address to the resolution server, in the event that a DNS update is desired, for example.

FIG. 9 illustrates a particular non-limiting high-level methodology that facilitates efficient and transparent remote wakeup of a target host according to various aspects of the disclosed subject matter. At 902, a separate address to receive wake up network traffic can be acquired by the target host (e.g., target host 102 or target host system 300). For instance, the normal IP address of a target host can be used for normal network traffic while the target host is operating. A separate IP address so acquired can be reserved for receiving wake up network traffic according to various aspects of the disclosed subject matter.

In addition, at 904, the separate address can be communicated to a remote host (e.g., remote host 104 or remote host system 400) prior to the target host entering a sleep mode. For example, prior to entering a low power and low availability state (e.g., a standby mode or sleep mode), the target host can send the separate IP address to a remote host 104 (e.g., or a trusted remote host 112) according to aspects of the disclosed subject matter. In addition, the separate address can be communicated to the remote host based on a determination of whether a remote host can be trusted. For example, the determination of whether the host requesting resolution of the target host can be trusted can be performed in part by an authentication component of the target host (e.g., directly or via a proxy or trusted third party entity such as a third host).

Moreover, at 904 a wake up policy can be communicated to the remote host, if desired. For example, a wake up policy can include restrictions on remote wake up operations based on such distinctions as described above (e.g., a time-based distinction, a network information based distinction, an application-based distinction, a user identity-based distinction, a host identity-based distinction, an event-based distinction, a state-based distinction, or a geographic related distinction). Additionally, a secure communication channel can be established with the remote host for securely communicating the separate address or the wake up policy.

At 906, wake up network traffic associated with the separate address can be received by the target host. As an example, target host can configure an associated network device to recognize patterns of network traffic as wake up network traffic. As a further example, such wake up network traffic can include, for example, an address resolution protocol (ARP) request associated with the separate address, and/or an internet protocol version six (IPv6) neighbor discovery request associated with the separate address, and so on.

Additionally, at 908 the target host can be restored from the sleep mode to resume network communications using an address distinct from the separate address. For example, upon resuming from a sleep mode, the target host can communicate the distinct address to the remote host. In addition, at 910, a new separate address can be used by the target host to receive subsequent wake up network traffic to prevent the remote host from performing subsequent remote wake up operations. For example, a separate IP address can be used for wake up network traffic so long as a remote host remains authorized to perform wake up operations. However, if it is desired to revoke such authorization, using a new separate IP address can facilitate revoking the authorization.

### Exemplary Networked and Distributed Environments

One of ordinary skill in the art can appreciate that the disclosed subject matter can be implemented in connection with any computer or other client or server device, which can be deployed as part of a computer network, or in a distributed computing environment, connected to any kind of data store. In this regard, the disclosed subject matter pertains to any computer system or environment having any number of memory or storage units, and any number of applications and processes occurring across any number of storage units or volumes, which can be used in connection with efficient and transparent remote wakeup in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices can have applications, objects or resources that implicate the systems and methods that facilitate efficient and transparent remote wakeup according to the disclosed subject matter.

FIG. 10 provides a schematic diagram of an exemplary networked or distributed computing environment. The distributed computing environment comprises computing objects 1010a, 1010b, etc. and computing objects or devices 1020a, 1020b, 1020c, 1020d, 1020e, etc. These objects can comprise programs, methods, data stores, programmable logic, etc. The objects can comprise portions of the same or different devices such as PDAs, audio/video devices, MP3 players, personal computers, etc. Each object can communicate with another object by way of the communications network 1040. This network can itself comprise other computing objects and computing devices that provide services to the system of FIG. 10, and can itself represent multiple interconnected networks. In accordance with an aspect of the disclosed subject matter, each object 1010a, 1010b, etc. or 1020a, 1020b, 1020c, 1020d, 1020e, etc. may contain an application that might make use of an API, or other object, software, firmware and/or hardware, suitable for use with the systems and methods that facilitate efficient and transparent remote wakeup in accordance with the disclosed subject matter.

It can also be appreciated that an object, such as 1020c, can be hosted on another computing device 1010a, 1010b, etc. or 1020a, 1020b, 1020c, 1020d, 1020e, etc. Thus, although the physical environment depicted may show the connected devices as computers, such illustration is merely exemplary and the physical environment can alternatively be depicted or described comprising various digital devices such as PDAs, televisions, MP3 players, etc., any of which can employ a variety of wired and wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many of the networks are coupled to the Internet, which provides an infrastructure for widely distributed computing and encompasses many different networks. Any of the infrastructures can be used for exemplary communications made incident to efficient and transparent remote wakeup according to the designs of the disclosed subject matter.

In home networking environments, there are at least four disparate network transport media that can each support a unique protocol, such as Power line, data (both wireless and wired), voice (e.g., telephone) and entertainment media. Most home control devices such as light switches and appliances may use power lines for connectivity. Data Services can enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic can enter the home either as wired (e.g., Cat 3) or wireless (e.g., cell phones) and can be distributed within the home using Cat 3 wiring. Entertainment media, or other graphical data, can enter the home either through satellite or cable and is typically distributed in the home using coaxial cable. IEEE 1394 and DVI are also digital interconnects for clusters of media devices. All of these network environments and others that emerge, or already have emerged, as protocol standards can be interconnected to form a network, such as an intranet, that can be connected to the outside world by way of a wide area network, such as the Internet. In short, a variety of disparate sources exist for the storage and transmission of data, and consequently, any of the computing devices of the disclosed subject matter may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 10, as an example, computers 1020a, 1020b, 1020c, 1020d, 1020e, etc. can be thought of as clients and computers 1010a, 1010b, etc. can be thought of as servers where servers 1010a, 1010b, etc. maintain the data that is then replicated to client computers 1020a, 1020b, 1020c, 1020d, 1020e, etc., although any computer can be considered a client, a server, or both, depending on the circumstances. Any of these computing devices can be processing data or requesting services or tasks that implicate the systems and methods that facilitate efficient and transparent remote wakeup in accordance with the disclosed subject matter.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques for efficient and transparent remote wakeup according to the disclosed subject matter can be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) can be coupled to one another via TCP/IP connection(s) for high-capacity communication.

Thus, FIG. 10 illustrates an exemplary networked or distributed environment, with server(s) in communication with client computer (s) via a network/bus, in which the disclosed subject matter can be employed. In more detail, a number of servers 1010a, 1010b, etc. are interconnected via a communications network/bus 1040, which can be a LAN, WAN, intranet, GSM network, the Internet, etc., with a number of client or remote computing devices 1020a, 1020b, 1020c, 1020d, 1020e, etc., such as a portable computer, handheld computer, thin client, networked appliance, or other device, such as a VCR, TV, oven, light, heater and the like in accordance with the disclosed subject matter. It is thus contemplated that the disclosed subject matter can apply to any computing device in connection with which it is desirable to provide efficient and transparent remote wakeup according to the disclosed subject matter.

In a network environment in which the communications network/bus 1040 is the Internet, for example, the servers 1010a, 1010b, etc. can be Web servers with which the clients 1020a, 1020b, 1020c, 1020d, 1020e, etc. communicate via any of a number of known protocols such as HTTP. Servers 1010a, 1010b, etc. can also serve as clients 1020a, 1020b, 1020c, 1020d, 1020e, etc., as can be characteristic of a distributed computing environment.

As mentioned, communications can be wired or wireless, or a combination, where appropriate. Client devices 1020a, 1020b, 1020c, 1020d, 1020e, etc. may or may not communicate via communications network/bus 14, and can have independent communications associated therewith. For example, in the case of a TV or VCR, there may or may not be a networked aspect to the control thereof. Each client computer 1020a, 1020b, 1020c, 1020d, 1020e, etc. and server computer 1010a, 1010b, etc. can be equipped with various application program modules or objects 1035a, 1035b, 1035c, etc. and with connections or access to various types of storage elements or objects, across which files or data streams can be stored or to which portion(s) of files or data streams can be downloaded, transmitted or migrated. Any one or more of computers 1010a, 1010b, 1020a, 1020b, 1020c, 1020d, 1020e, etc. can be responsible for the maintenance and updating of a database 1030 or other storage element, such as a database or memory 1030 for storing data processed or saved according to the disclosed subject matter. Thus, the disclosed subject matter can be utilized in a computer network environment having client computers 1020a, 1020b, 1020c, 1020d, 1020e, etc. that can access and interact with a computer network/bus 1040 and server computers 1010a, 1010b, etc. that can interact with client computers 1020a, 1020b, 1020c, 1020d, 1020e, etc. and other like devices, and databases 1030.

### Exemplary Computing Device

As mentioned, the disclosed subject matter applies to any device wherein it can be desirable to provide efficient and transparent remote wakeup. It should be understood, therefore, that handheld, portable and other computing devices and computing objects of all kinds are contemplated for use in connection with the disclosed subject matter, i.e., anywhere that a capable device can provide or request remote wakeup of a host or otherwise receive, process or store data. Accordingly, the below general purpose remote computer described below in FIG. 11 is but one example, and embodiments of the disclosed subject matter may be implemented with any client having network/bus interoperability and interaction. Thus, the disclosed subject matter can be implemented in an environment of networked hosted services in which very little or minimal client resources are implicated, e.g., a networked environment in which the client device serves merely as an interface to the network/bus, such as an object placed in an appliance.

Although not required, the disclosed subject matter can partly be implemented via an operating system, for use by a developer of services for a device or object, and/or included within application software that operates in connection with the component(s) of the disclosed subject matter. Software may be described in the general context of computer executable instructions, such as program modules, being executed by one or more computers, such as client workstations, servers or other devices. Those skilled in the art will appreciate that the disclosed subject matter can be practiced with other computer system configurations and protocols.

FIG. 11 thus illustrates an example of a suitable computing system environment 1100a in which the disclosed subject matter can be implemented, although as made clear above, the computing system environment 1100a is only one example of a suitable computing environment for a media device and is not intended to suggest any limitation as to the scope of use or functionality of the disclosed subject matter. Neither should the computing environment 1100a be interpreted as having any dependency or requirement relating to any one or combination of components illustrated in the exemplary operating environment 1100a.

With reference to FIG. 11, an exemplary remote device for implementing the disclosed subject matter includes a general purpose computing device in the form of a computer 1110a. Components of computer 1110a can include, but are not limited to, a processing unit 1120a, a system memory 1130a, and a system bus 1121a that couples various system components including the system memory to the processing unit 1120a. The system bus 1121a can be any of several types of bus structures including a memory bus or memory controller, a peripheral bus, and a local bus using any of a variety of bus architectures.

Computer 1110a typically includes a variety of computer readable media. Computer readable media can be any available media that can be accessed by computer 1110a. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110a. Communication media typically embodies computer readable instructions, data structures, program modules or other data in a modulated data signal such as a carrier wave or other transport mechanism and includes any information delivery media.

The system memory 1130a can include computer storage media in the form of volatile and/or nonvolatile memory such as read only memory (ROM) and/or random access memory (RAM). A basic input/output system (BIOS), containing the basic routines that help to transfer information between elements within computer 1110a, such as during start-up, can be stored in memory 1130a. Memory 1130a typically also contains data and/or program modules that are immediately accessible to and/or presently being operated on by processing unit 1120a. By way of example, and not limitation, memory 1130a can also include an operating system, application programs, other program modules, and program data.

The computer 1110a can also include other removable/non-removable, volatile/nonvolatile computer storage media. For example, computer 1110a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1121a through a non-removable memory interface such as an interface, and a magnetic disk drive or optical disk drive is typically connected to the system bus 1121a by a removable memory interface, such as an interface.

A user can enter commands and information into the computer 1110a through input devices such as a keyboard and pointing device, commonly referred to as a mouse, trackball or touch pad. Other input devices can include a microphone, joystick, game pad, satellite dish, scanner, or the like. These and other input devices are often connected to the processing unit 1120a through user input 1140a and associated interface(s) that are coupled to the system bus 1121a, but can be connected by other interface and bus structures, such as a parallel port, game port or a universal serial bus (USB). A graphics subsystem can also be connected to the system bus 1121a. A monitor or other type of display device is also connected to the system bus 1121a via an interface, such as output interface 1150a, which can in turn communicate with video memory. In addition to a monitor, computers can also include other peripheral output devices such as speakers and a printer, which can be connected through output interface 1150a.

The computer 1110a can operate in a networked or distributed environment using logical connections to one or more other remote computers, such as remote computer 1170a, which can in turn have media capabilities different from device 1110a. The remote computer 1170a can be a personal computer, a server, a router, a network PC, a peer device or other common network node, or any other remote media consumption or transmission device, and can include any or all of the elements described above relative to the computer 1110a. The logical connections depicted in FIG. 11 include a network 1171a, such local area network (LAN) or a wide area network (WAN), but can also include other networks/buses. Such networking environments are commonplace in homes, offices, enterprise-wide computer networks, intranets and the Internet.

When used in a LAN networking environment, the computer 1110a is connected to the LAN 1171a through a network interface or adapter. When used in a WAN networking environment, the computer 1110a typically includes a communications component, such as a modem, or other means for establishing communications over the WAN, such as the Internet. A communications component, such as a modem, which can be internal or external, can be connected to the system bus 1121a via the user input interface of input 1140a, or other appropriate mechanism. In a networked environment, program modules depicted relative to the computer 1110a, or portions thereof, can be stored in a remote memory storage device. It will be appreciated that the network connections shown and described are exemplary and other means of establishing a communications link between the computers can be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the disclosed subject matter can also be implemented via an operating system, or a “middle man” object, a control object, hardware, firmware, intermediate language instructions or objects, etc., such that the systems and methods that facilitate efficient and transparent remote wakeup in accordance with the disclosed subject matter can be included in, supported in or accessed via all of the languages and services enabled by managed code, such as .NET code, and in other distributed computing frameworks as well.

There are multiple ways of implementing the disclosed subject matter, e.g., an appropriate API, tool kit, driver code, operating system, control, standalone or downloadable software object, etc. which enables applications and services to use the methods that facilitate efficient and transparent remote wakeup and related systems of the disclosed subject matter. The disclosed subject matter contemplates the use of the disclosed subject matter from the standpoint of an API (or other software object), as well as from a software or hardware object that facilitates efficient and transparent remote wakeup in accordance with the disclosed subject matter. Thus, various implementations of the disclosed subject matter described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the disclosed subject matter have been described in connection with various computing devices and network architectures, the underlying concepts can be applied to any computing device or system in which it is desirable to provide remote wakeup capabilities. For instance, the systems and methods that facilitate efficient and transparent remote wakeup in accordance with the disclosed subject matter can be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the disclosed subject matter.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. One or more components can reside within a process and/or thread of execution and a component can be localized on one computer and/or distributed between two or more computers.

Thus, the methods and apparatus of the disclosed subject matter, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the disclosed subject matter. In the case of program code execution on programmable computers, the computing device generally includes a processor, a storage medium readable by the processor (including volatile and non-volatile memory and/or storage elements), at least one input device, and at least one output device. One or more programs that can implement or utilize the efficient and transparent remote wakeup methods of the disclosed subject matter, e.g., through the use of a data processing API, reusable controls, or the like, are preferably implemented in a high level procedural or object oriented programming language to communicate with a computer system. However, the program(s) can be implemented in assembly or machine language, if desired. In any case, the language can be a compiled or interpreted language, and combined with hardware implementations.

The methods and apparatus of the disclosed subject matter may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the disclosed subject matter. When implemented on a general-purpose processor, the program code combines with the processor to provide a unique apparatus that operates to invoke the functionality of the disclosed subject matter. Additionally, any storage techniques used in connection with the disclosed subject matter may invariably be a combination of hardware and software.

Furthermore, portions of the disclosed subject matter can be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

Furthermore, as will be appreciated various portions of the disclosed systems and methods can include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the disclosed subject matter has been described in connection with the preferred embodiments of the various figures, it is to be understood that other similar embodiments can be used or modifications and additions can be made to the described embodiment for performing the same function of the disclosed subject matter without deviating therefrom. For example, while exemplary network environments of the disclosed subject matter are described in the context of a networked environment, such as a peer to peer networked environment, one skilled in the art will recognize that the disclosed subject matter is not limited thereto, and that the methods, as described in the present application can apply to any computing device or environment, such as a gaming console, handheld computer, portable computer, etc., whether wired or wireless, and can be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the disclosed subject matter in the context of particular programming language constructs, the disclosed subject matter is not so limited, but rather may be implemented in any suitable language to provide efficient and transparent remote wakeup systems, and related methods. Still further, the disclosed subject matter can be implemented in or across a plurality of processing chips or devices, and storage can similarly be effected across a plurality of devices. Therefore, the disclosed subject matter should not be limited to any single embodiment, but rather should be construed in breadth and scope in accordance with the appended claims.

What is claimed is:

1. A method facilitating remote wake up of a target host, the method comprising:
acquiring, by the target host, a separate address to receive wake up network traffic;
communicating the separate address to a computer system prior to the target host entering a sleep mode; and
receiving, by the target host, wake up network traffic associated with the separate address.

2. The method of claim 1, further comprising restoring, by the target host, from the sleep mode to resume network communications using an address distinct from the separate address.

3. The method of claim 2, further comprising communicating the address distinct from the separate address to the computer system.

4. The method of claim 1, further comprising communicating a wake up policy to the computer system, the wake up policy includes restrictions on remote wake up operations based at least in part on a time-based distinction, a network information based distinction, an application-based distinction, a user identity-based distinction, a host identity-based distinction, an event-based distinction, a state-based distinction, or a geographic related distinction.

5. The method of claim 1, further comprising establishing a secure communication channel with the computer system for securely communicating at least one of the separate address or the wake up policy.

6. The method of claim 1, the wake up network traffic includes at least one of an address resolution protocol request associated with the separate address or an internet protocol version six neighbor discovery request associated with the separate address.

7. The method of claim 1, the computer system is a remote host.

8. The method of claim 7, further comprising using, by the target host, a new separate address to receive subsequent wake up network traffic to prevent the remote host from performing subsequent remote wake up operations.

9. The method of claim 7, the communicating includes communicating the separate address to the remote host based in part on a determination of whether the remote host can be trusted.

10. The method of claim 9, the determination of whether the remote host can be trusted is performed in part by an authentication component of a third host.

11. The method of claim 1, the computer system is a resolution server.

12. The method of claim 11, the receiving includes receiving wake up network traffic associated with the separate address from the resolution server based at least in part on a determination of whether a host requesting resolution of the target host can be trusted or allowed by the wake up policy.

13. The method of claim 12, the determination of whether the host requesting resolution of the target host can be trusted is performed in part by an authentication component of the resolution server.

14. A system facilitating remote wake up, the system comprising a target host, the target host further comprising:
a storage component for storing data and instructions for placing the target host in a sleep mode, setting one or more wake up traffic patterns, and waking the target host upon receiving one of the one or more wake up traffic patterns; and
a communication component configured to receive network traffic associated with a first address when the target host is not in the sleep mode, to receive and recognize network traffic associated with a second address as one of the one or more wake up traffic patterns when the target host is in the sleep mode, and to signal the target host to resume from the sleep mode based in part on the recognition of one of the one or more wake up traffic patterns.

15. The system of claim 14, the communication component is further configured to send at least one of a wake up policy or the second address to one or more of a remote host or a resolution server, the wake up policy restricts remote wake up of target host based at least in part on a time-based distinction, a network information based distinction, an application-based distinction, a user identity-based distinction, a host identity-based distinction, an event-based distinction, a state-based distinction, or a geographic related distinction.

16. The system of claim 14, the target host further comprising an authentication component configured to authorize remote wake up of the target host by the remote host.

17. The system of claim 14, the one or more wake up traffic patterns includes at least one of an address resolution protocol request associated with the second address or an internet protocol version six neighbor discovery request associated with the second address.

18. A system facilitating remote wake up, the system comprising a resolution server, the resolution server further comprising:
an authentication component configured to determine whether a remote host is authorized to remotely wake up a target host; and
a communication component configured to receive a wake up address associated with the target host, the wake up address is distinct from a normal address of the target host, to transmit network traffic to the wake up address associated with the target host based in part on whether the remote host is authorized to remotely wake up the target host, and to transmit the normal address of the target host to the remote host based on a resolution protocol.

19. The system of claim 18, the communication component is further configured to receive wake up policy information concerning the target host, the wake up policy information facilitates restricting remote wake up of the target host based at least in part on a time-based distinction, a network information based distinction, an application-based distinction, a user identity-based distinction, a host identity-based distinction, an event-based distinction, a state-based distinction, or a geographic related distinction.

20. The system of claim 18, further comprising a cryptographic component configured to establish a secure channel for securely receiving at least one of the wake up address or the wake up policy information concerning the target host.
